(19) United States
(12) Patent Application Publication
(10) Pub. No.: US 2007/0118801 A1
(43) Pub. Date: May 24, 2007

(54) GENERATION AND PLAYBACK OF MULTIMEDIA PRESENTATIONS

(75) Inventors: Steven Harshbarger, Corte Madera, CA (US); Robert W. Beth, Jackson, WY (US)

Correspondence Address: BEYER WEAVER LLP, P.O. BOX 70250, OAKLAND, CA, 94612-0250, US

(73) Assignee: VIZZME, INC., Jackson, WY (US)

(21) Appl. No.: 11/562,322

(22) Filed: Nov. 21, 2006

Related U.S. Application Data
(60) Provisional application No. 60/739,184, filed on Nov. 23, 2005.
(60) Provisional application No. 60/829,847, filed on Oct. 17, 2006.
(60) Provisional application No. 60/852,572, filed on Oct. 17, 2006.

(51) Int. Cl. G06F 17/00; H04N 5/44

(52) U.S. Cl. 715/730; 715/716; 715/500.1

(57) ABSTRACT

Methods and apparatus are described which employ a new media type built on the concept of assembling a “story” from intelligent, large-grained containers rather than placing the constituent parts of a presentation on a fixed timeline.

### RELATED APPLICATION DATA

The present application claims priority under 35 U.S.C. 119(e) to each of U.S. Provisional Patent Application No. 60/739,184 filed on Nov. 23, 2005 (Attorney Docket No. VIZZP001P), U.S. Provisional Patent Application No. 60/829,847 filed on Oct. 17, 2006 (Attorney Docket No. VIZZP001P2), and U.S. Provisional Patent Application No. 60/852,572 filed on Oct. 17, 2006 (VIZZP001P3), the entire disclosure of each of which is incorporated herein by reference for all purposes.

### BACKGROUND OF THE INVENTION

The present invention relates to techniques for producing, distributing, and playback of multimedia presentations.

There are many tools available for generating presentations having audio and visual components. In particular, there are a number of highly sophisticated tools for generating and editing video presentations. The video editing techniques associated with such tools typically rely on the concept of continuous, synchronized tracks which specify the sequencing and timing of the content of the video. These techniques work at a very detailed or small-grained level (e.g., 30 frames per second) in specifying the registration of the beginning and end of the various types of largely continuous content and, in the case of still images, specifying in detail where to begin and end the continuous display of the still image. Unfortunately, the level of user sophistication required to generate relatively simple videos using such tools is a significant hurdle to their widespread acceptance.

In view of the foregoing, improved techniques for generating multimedia presentations are desirable.

### SUMMARY OF THE INVENTION

According to specific embodiments of the present invention, methods and apparatus are provided for generating a multimedia presentation. First interfaces are presented which are operable by a first user to associate visual objects with frame objects. Second interfaces are presented which are operable by the first user to associate audio objects with the frame objects. A third interface is presented which is operable by the first user to manipulate the frame objects and to thereby modify a presentation object corresponding to a sequence of the frame objects. Manipulation of each frame object results in corresponding manipulation of the associated visual and audio objects. The first, second, and third interfaces are together operable to facilitate configuration of the presentation object, the frame objects, and the visual and audio objects in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

According to other specific embodiments, methods and apparatus are provided for facilitating playback of a multimedia presentation. A presentation object representing a sequence of frame objects is instantiated. Each of the frame objects has associated visual and audio objects. The presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

According to further specific embodiments, a platform is provided for facilitating generation of a plurality of multimedia presentations by a plurality of users. At least one computing device is configured to implement a production process for generating the multimedia presentations. Each of the multimedia presentations includes visual objects and audio objects configured as a plurality of frame objects. The frame objects are configured as a sequence represented by a presentation object. The presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation. The at least one computing device is further configured to implement at least one distribution process for facilitating playback of the multimedia presentations by the plurality of users.

According to still further specific embodiments, at least one computer-readable medium is provided having data structures stored therein representative of a multimedia presentation. The data structures represent visual objects and audio objects configured as a plurality of frame objects. The frame objects are configured as a sequence represented by a presentation object. The presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

A further understanding of the nature and advantages of the present invention may be realized by reference to the remaining portions of the specification and the drawings.

### BRIEF DESCRIPTION OF THE DRAWINGS

FIG. 1 is a simplified block diagram illustrating a specific implementation of an object model for a multimedia presentation according to a specific embodiment of the invention.

FIGS. 2-7 are simplified representations of various objects or “containers” enabled by specific embodiments of the invention.

FIGS. 8-10 are exemplary XML representations of portions of multimedia presentations according to specific embodiments of the invention.

FIG. 11 is a flow diagram which illustrate techniques production of multimedia presentations according to various embodiments of the invention.

FIGS. 19A-22 are flow diagrams which illustrate techniques for distribution, playback, remixing, and providing feedback relating to multimedia presentations according to various embodiments of the invention.

FIGS. 12-17 is a series of screen shots illustrating creation of a multimedia presentation according to a specific embodiment of the invention.

FIG. 18 illustrates a camera designed according to a specific embodiment of the invention.

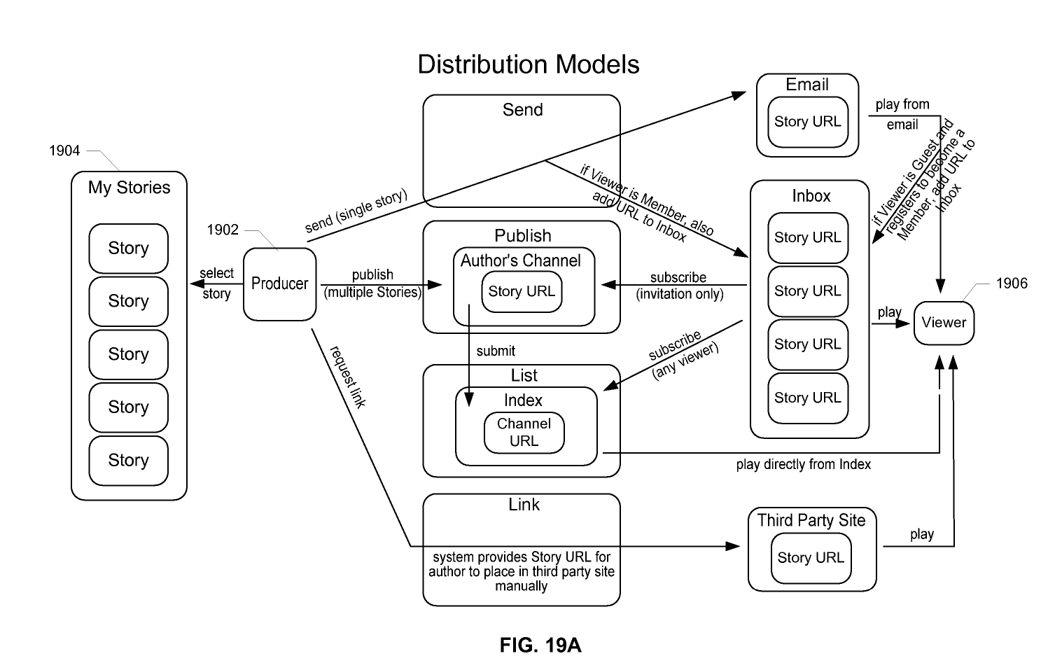

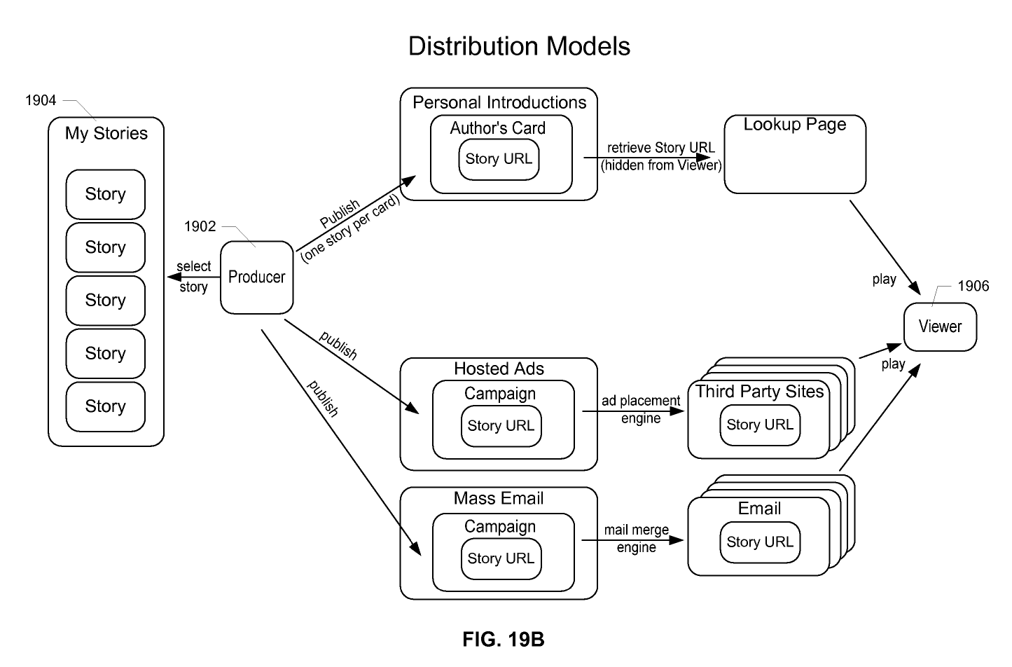

FIGS. 19A-22 are flow diagrams which illustrate techniques for distribution, playback, remixing, and providing feedback relating to multimedia presentations according to various embodiments of the invention.

FIG. 23 is a simplified network diagram illustrating computing platforms and environments in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention dramatically simplify the process of creating and editing multimedia presentations with program logic flows which employ large-grained, discrete, intelligent objects, referred to herein as “containers,” to generate and play multimedia presentations that are perceived by viewers as videos. Each such container may include multimedia content of a wide variety of media types including, but not limited to, video clips, flash animations, still images, audio clips, textual information, and any suitable alternative. It should be noted that the terms “container” and “contain” as used herein are intended to include cases in which the content or information referred to as being “contained” may be a variety of different representations of that content or information. That is, the content or information may itself be included within the container. Alternatively, some representation of the content or information (e.g., a pointer, a link, a file name, etc.) might be included within the container. The various alternatives understood by those of skill in the art to effect the resulting functionality are therefore contemplated as within the scope of the invention.

According to some embodiments, a container may also include multiple versions of some content. For example, in the case of spoken narration, there may be audio clips in several different spoken languages. In the case of still images or video, there may be content flagged as adult content. In the case of textual information, there may be content in multiple languages and character sets.

According to various embodiments, to play a such a presentation (or alternatively to generate a video file format from such a presentation), a control structure, e.g., a presentation “player,” passes certain parameters, e.g., language or adult-only flags, which determine how the presentation will be instantiated for viewing.

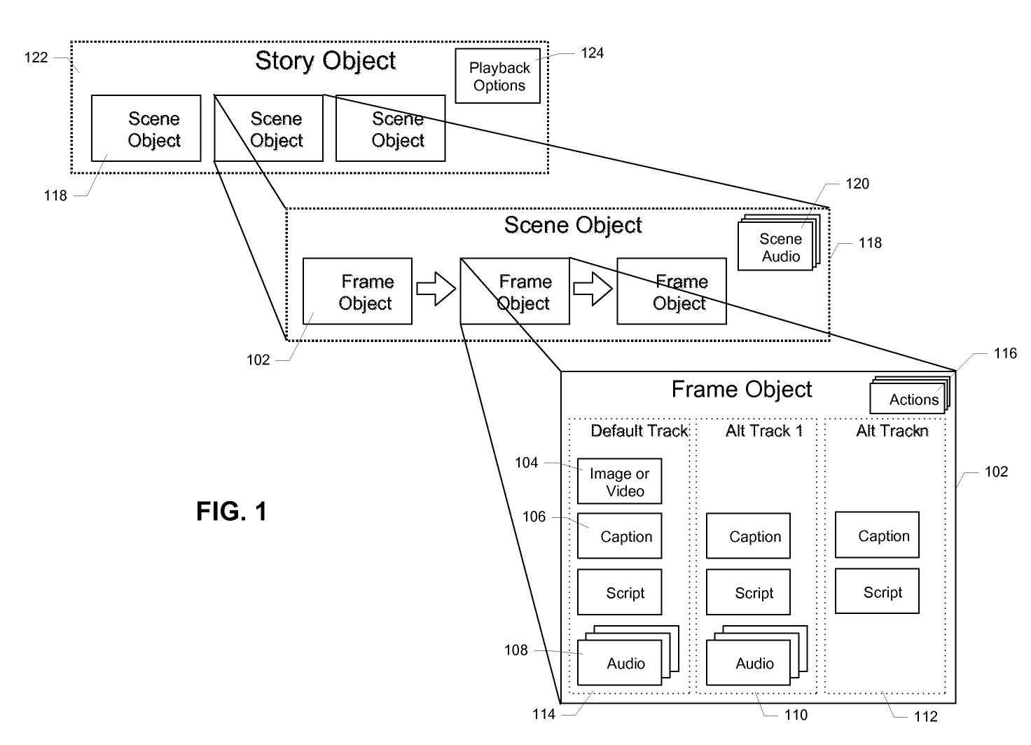

According to a specific class of embodiments, a multimedia presentation, referred to herein as a “story,” corresponds to a hierarchy of related container objects referred to herein as frames, scenes, and stories. An exemplary illustration of the relationship among these objects is illustrated in FIG. 1.

Frame objects or frames 102 include media elements intended to be played as a unit. A frame may include, for example, a visual element 104 (e.g., image or video clip), a caption element, 106, and one or more audio elements 108. According to a specific embodiment, the visual and caption elements of a frame are displayed for the duration of their audio elements. A frame can optionally contain multiple audio elements which play in a stated order.

According to specific embodiments, a frame may also optionally contain alternative tracks, e.g., tracks 110 and 112, which are used to render alternate versions of the same frame. For example, a frame may be rendered differently for different audiences (e.g., alternative visual elements (both video and still images), different narrators, different languages, etc.). The ability to produce frames having multiple tracks enables multiple versions of a story to be represented by a single story object such that the version presented at playback time is appropriate to the particular viewer.

According to a more specific embodiment, to avoid duplication of frame elements which are intended to be instantiated with different versions, alternative tracks may omit a particular media element (e.g., the visual element), in which case the omitted element from default track 114 is used.

Frame 102 may also contain “actions” 116 which may comprise, for example, links to other scenes, frames, or an arbitrary process external to the frame.

Scene objects or scenes 118 organize frames 102 in a playback sequence in which, after each frame is rendered, the next frame in the sequence is played. Because the content elements of a frame are organized as a single object, the frames within a scene may be easily rearranged. Scenes may optionally contain their own audio elements 120 which play simultaneously as frames are rendered. This allows audio to span over the content elements of multiple frames.

The highest level object in such embodiments is the story object or story 122 which contains one or more scenes 118. Story 122 may also contain options 124 for rendering the story at playback time. For example, one such option could provide different playback modes such as a linear mode in which each scene plays back to back in a stated order, or an index mode in which the viewer is presented with a list of scenes to play in any desired order.

According to some embodiments, every object in the hierarchy has an owner. In general, this corresponds to the user who originally created the object. As will be discussed, this attribute enables a variety of useful functionality.

As will be discussed, the object model shown in FIG. 1 enables a wide variety of advantages and functionalities depending on which aspects of the model are included. For example, because related audio and visual elements are grouped within the context of a frame, this enables these elements to be resequenced as a unit. Similarly, related frames grouped in a scene may also be resequenced within a story as a unit. As will be understood, this eliminates the complexity of managing parallel elements on a timeline as is typical of conventional video and audio editing software.

Another advantage of the model of FIG. 1 is that objects at various levels of the hierarchy can (subject to the owner's reuse policy) be copied into other stories, scenes, or frames. That is, entire stories, specific scenes, individual frames, and media elements may all be reused. And once copied, such reused objects may be further edited.

According to some embodiments, the object model of FIG. 1 may also facilitate collaborative editing. For example, the notion of object ownership may enable multi-user editing in which a story owner grants full or limited editing rights to specific collaborators. Limited collaborators might be able to add/edit their own objects in the story, where full collaborators would be able to edit all objects in a story.

Object ownership may also facilitate a form of digital rights management in that object owners are enable to designate whether or not specific objects are “remixable.” That is, remixable objects may be reused by others, while non-remixable objects cannot. This would be enforced by both player and editing software. In another example, object ownership may facilitate a form of access control based on levels of security or authorization. For example, in a classified government context, users having “secret” level clearances would not be able to view or hear “top secret” level content. Again, the notion of tracks could be leveraged to present one version of the story to one level of user, e.g., those with secret clearances, and another version to another level of user, e.g., those with top secret clearances. In yet another example, object ownership may facilitate tracking compliance workflow for content where the content needs to be approved before making it viewable, e.g., enforcing absence of copyright material or absence of pornographic, obscene, or otherwise objectionable material, etc.

According to some embodiments, the object model illustrated in FIG. 1 allows viewers to experiences stories in both linear and non-linear modes. In such a linear playback mode, the viewer may be enabled to skip ahead or back by frame or scene in the arranged sequence. This is distinguishable from conventional video or audio fast-forward or rewind since the skip increments are tied to content objects instead of time.

In an nonlinear or index playback mode, the viewer is presented with a list of scenes which they can select and play at their discretion. Intermediate menus may also be displayed to allow playback to branch to different scenes based on viewer input. In addition, frames can contain actions which enable jumping to another scene or frame in the story, thus allowing the viewer to choose their own path through the story.

Embodiments in which multiple tracks are included in frames enable alternate versions within a single story which may be instantiated with different content targeted at different viewers. For example, different tracks could be provided to support presentations having different ratings relative to adult content. In another example, different tracks could be provided for each of a plurality of languages. At playback time, a viewer may be given the option to designate which tracks should be played. Alternatively, options can be presented or tracks can be hidden from specific viewers, e.g., based on profile information. According to some embodiments, the viewer can be given the option to select more than one track to render during a single playback. Such a features would be useful, for example, in a situation in which the viewer wants to play English and then Spanish for each frame. In addition, in embodiments employing multiple tracks, stories can be exported for rendering to common video formats with options to create multiple video files which employ different tracks.

And because stories are object oriented, detailed metrics may be collected in some implementations regarding how a viewer interacts with a story as it is being viewed. For example, a variety of user actions can be tracked including which frames are played, which frames are skipped, which scenes are played, which tracks are played, etc. Such metrics may then be used to measure viewer behavior and/or story effectiveness.

Specific embodiments of the invention are described herein using the following terminology to refer to different types of users. It should be understood that this terminology is used herein for exemplary purposes and should not be used to limit the scope of the invention. The term “member” refers to a person having an account on the described platform. A “guest” is a person without an account on the platform. A “producer” is a member in the role of creating or distributing a story. A “contributor” is a member in the role of adding content to a producer's story. An “author” is a term inclusive of both producers and contributors. A viewer is a member or guest in the role of viewing a story. Finally, an operator is an entity, e.g., an enterprise, responsible for operating and managing a service or platform designed in accordance with the invention.

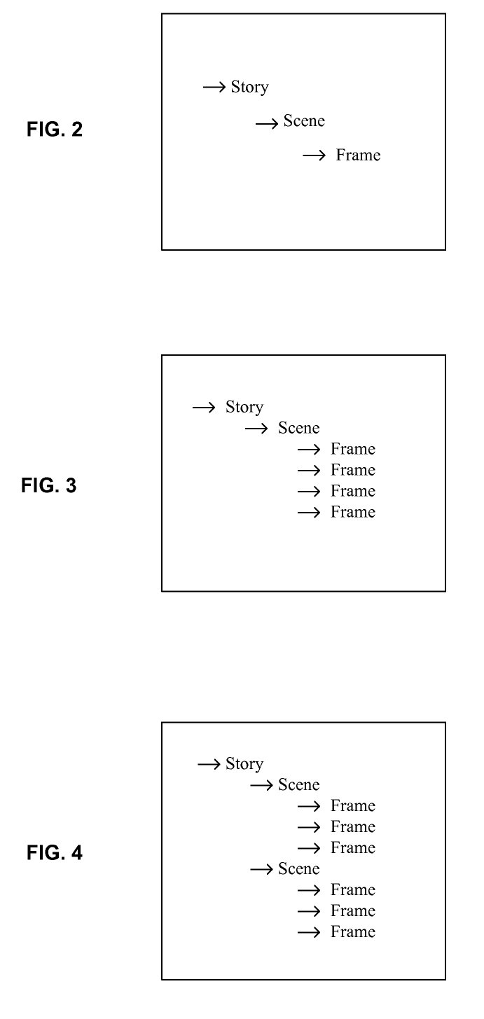

Specific implementations of a platform which enables both story production and story playback is described below. However, a more detailed discussion of the an exemplary story format will be useful. As discussed above, the major elements of a multimedia presentation according to specific embodiments of the invention are the story, the scene, and the frame. Consider the diagram of FIG. 2. As illustrated, a story is the top-level container for content. A frame includes a visual element (e.g., image or video clip) to be displayed with one or more audio elements (e.g., a narration). A scene is a grouping of frames. A story can contain one or more scenes, and a scene can contain one or more frames. At a minimum, a story contains one scene and one frame.

By way of example, a simple story comprising a narrated sequence of images might look something like the diagram of FIG. 3. By contrast, a more complicated story (potentially with branching content) might use a collection of scenes as shown in FIG. 4.

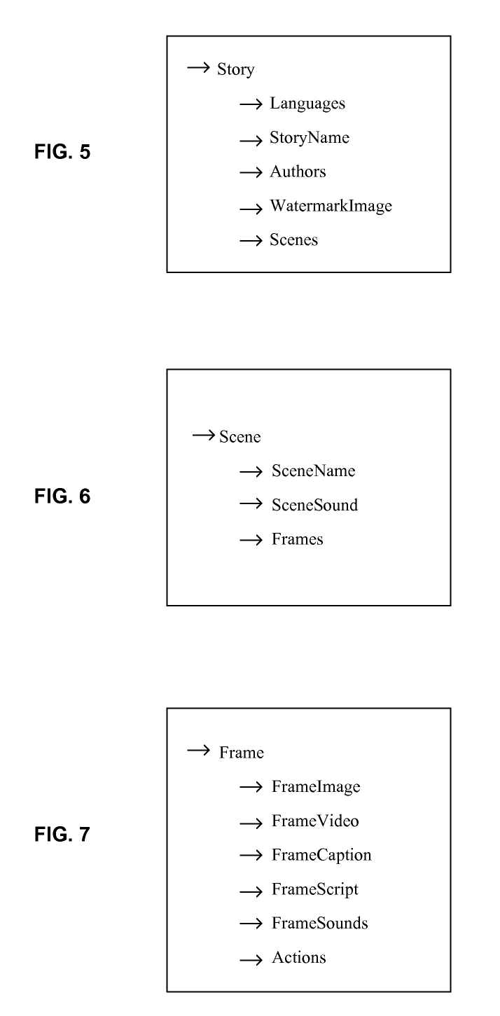

As shown in the more detailed diagram of FIG. 5, in addition to scenes, a story includes additional information to facilitate rendering of the content to the viewer. These elements apply to the story as a whole and may include, for example, a list of languages in which the story may be presented, a descriptive name of the story, a list of individuals who contributed content to the story (one of which is the producer that “owns” the story, the others of which are contributors), a watermark image to display over each frame in the story (e.g., for branding, copyrighting, and/or advertising purposes), and the scenes associated with the story.

As discussed above, a scene is a grouping of frames. According to a specific implementation, scenes enable three things; content branching, rudimentary timelines, and soundtrack audio. Content branching is implemented by creating a different scene for each branch. Rudimentary timelines may be implemented by setting specific frame durations within a scene. Both this feature and soundtrack audio will be explained in greater detail below.

As shown in the more detailed diagram of FIG. 6, in addition to frames, a scene includes additional information to facilitate rendering of the scene content. These elements apply to the specific scene and may include, for example, a descriptive name for the scene, and one or more audio elements to be played over a sequence of frames within the scene. These scene-level audio elements may be used as an alternative to frame-level audio elements, or in an addition to frame-level audio, e.g., as background music while frame narrations are played.

As discussed above, a frame is the smallest unit of display in a story, and may contain both visual and audio elements. The visual element may be an image (with optional caption), video (with optional caption), or title text (i.e., without an image). The audio element plays while the visual element is displayed. As illustrated in FIG. 7, a frame may include an image to display for the frame, a video clip to display for the frame, and a frame caption, e.g., text relating to the image or video. In cases where the frame does not have an visual element, the frame caption may function as a standalone title for the frame. The frame may also include a frame script, i.e., text of the narration for the frame. This might be used, for example, in story production workflow when the author wants to read the narration from a script. It may also be used for hearing impaired viewers as the text to display with the frame in lieu of audio. A frame may also include one or more frame sounds to accompany presentation of the frame, and actions which represent interactive features on the frame.

The frame sounds are a collection of audio elements to be played while a frame is displayed. Each frame sound may represent audio contributed by a different author. Typically, the frame sounds collection will contain a simple list of frame sound objects to play. More complex applications may specify types of frame sounds referred to herein as “intro sounds” and “outro sounds” which are played before and after the collection of normal frame sounds, respectively. This may be used to allow the narration to be spaced out over a fixed interval of time with silence in between. It may also be used to introduce audio clips that are mapped to the recipient in manner evocative of mail merge in word processing.

An action is an interactive feature associated with a frame. In some implementations, it may take the form of a button or a link although, depending on the device, other renderings may be appropriate.

According to some embodiments of the invention, and as mentioned above, a multimedia presentation based on the story structure described above may be rendered in an arbitrary number of alternate versions using substitute media elements (e.g., different languages, alternate content, etc.) which are stored in different tracks associated with a frame. This structure may be leveraged to deliver different versions of the same story in one story container or object. According to some implementations which enable versions in different languages, the viewer experiences this by selecting a language before starting playback of the story. The player application then renders the content in the selected language. This feature may associate different text and audio with an image in a frame, and is flexible enough to enable different visual elements for a frame as well. According to specific embodiments, a list of tracks is defined at the story level, one of which is identified as the default track. These tracks may be identified, for example, by language codes (http://ftp.ics.uci.edu/pub/ietf/http/related/iso639.txt), locale codes (i.e., a combination of language code and country code: http://www.iso.org/iso/en/prods-services/iso3166ma/02iso-3166-code-lists/list-enl.html), or any arbitrary label the user wishes to assign (e.g., “clean” vs. “explicit”). Throughout the rest of the object hierarchy, elements may then be tagged with these track identifiers to facilitate presentation of alternative versions.

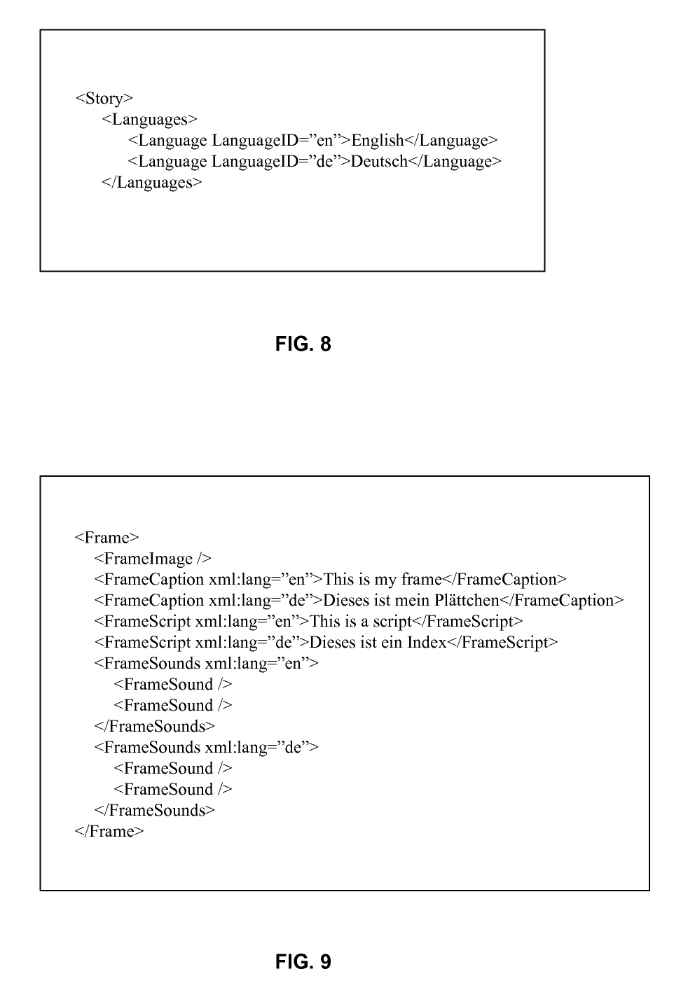

According to a specific embodiment, each element of a story with alternate versions appears multiple times. Each instance is tagged with an applicable version attribute. The player application then selects the elements by tag corresponding to the desired version when playing a story. According to a more specific embodiment, this functionality is implemented according to the xml language standard described at http://www.w3.org/TR/REC-xml/, the entire disclosure of which is incorporated herein by reference for all purposes, under heading 2.12-Language Identification. As shown in FIG. 8, a list of available languages may be defined at the story level using ISO 639 2 letter language codes (see http://www.w3.org/WAI/ER/IG/ert/iso639.htm). With this in place, any other element in the Story can be repeated and tagged with a language attribute.

For example, at the frame level, all the elements can be language tagged. In the example shown in FIG. 9, a single image is used for two different languages, with different captions, scripts, and sounds being available for each. It should be noted that this mechanism applies to many more of the elements in the story format.

For stories that do not contain different language versions, use of the language mechanism is optional. The <Languages> list at the story level can be omitted, and all content elements can appear just once without an xml:Lang attribute. In this case, the player application simply plays all the content.

Furthermore, specific elements in an otherwise language-specific story can be made to apply to all language versions simply by having a single instance of the element and omitting the xml:Lang attribute. A common example of this would be using the same image on a frame for all languages. This is demonstrated in the example of FIG. 9.

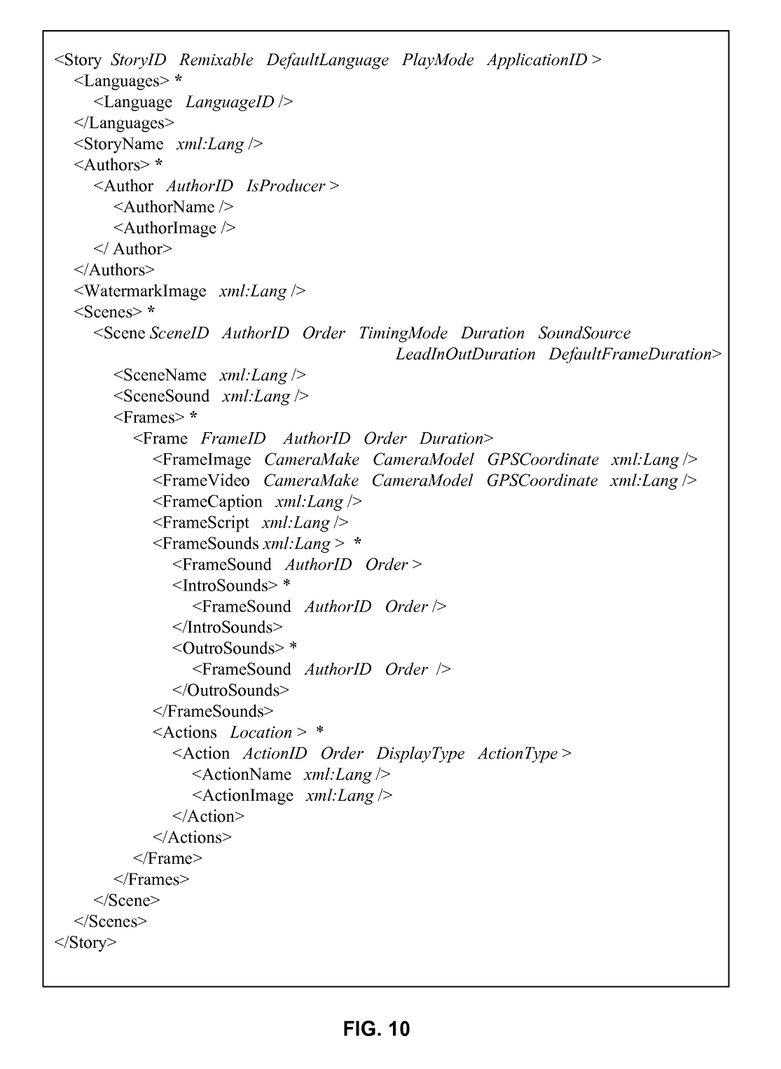

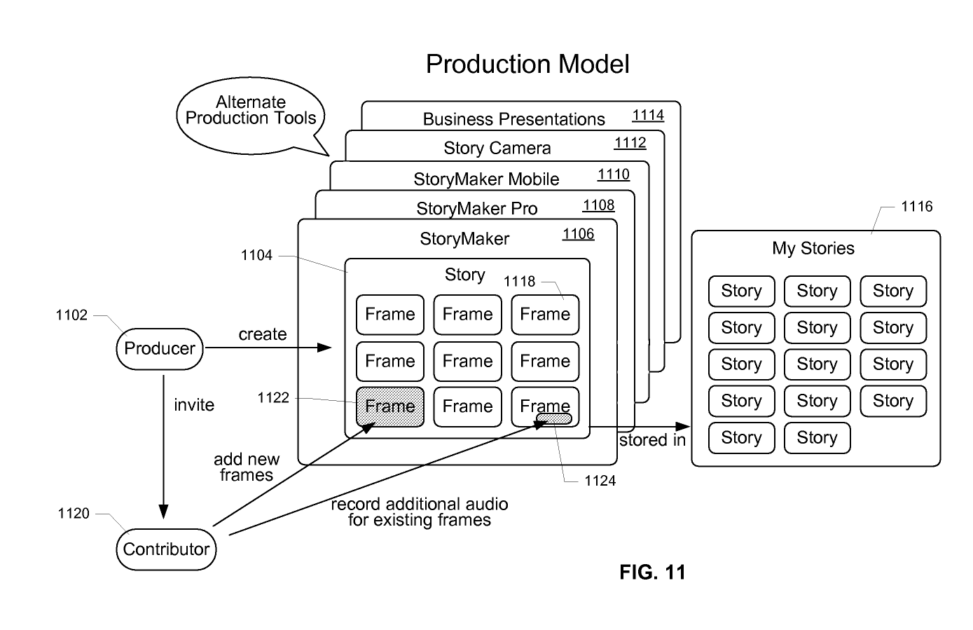

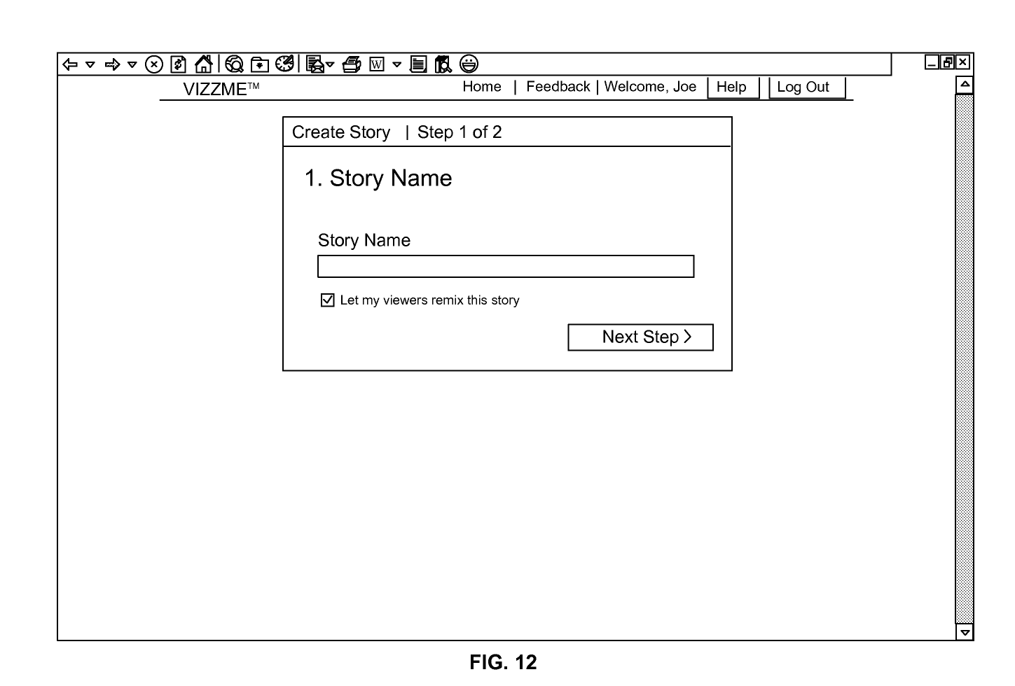

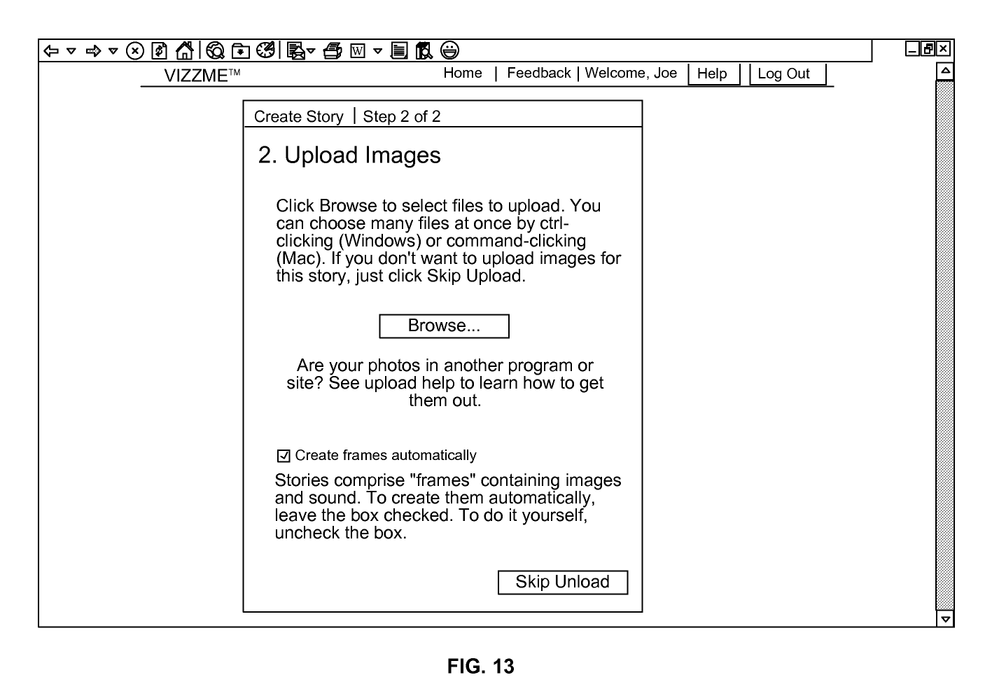

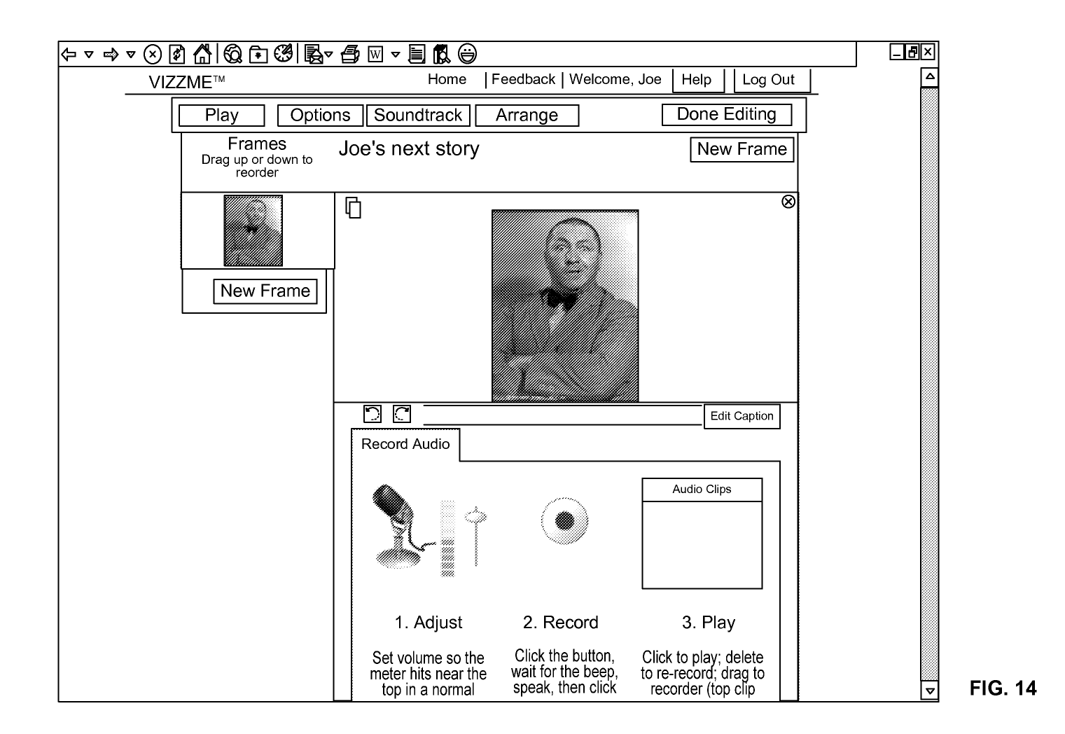

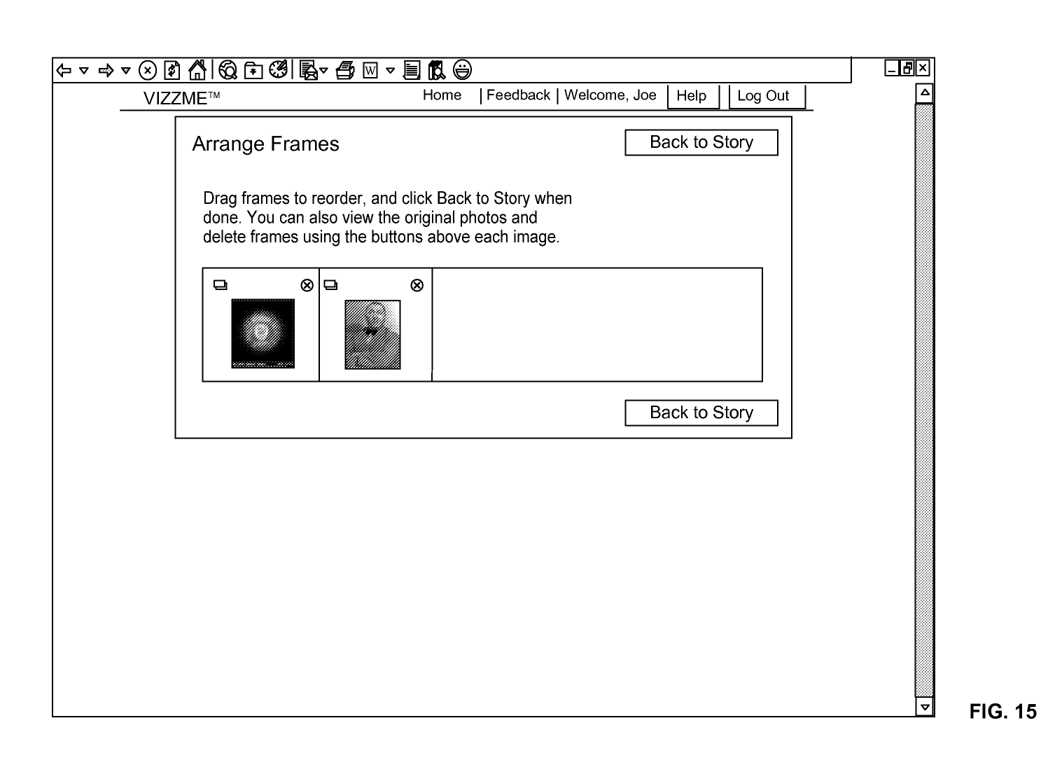

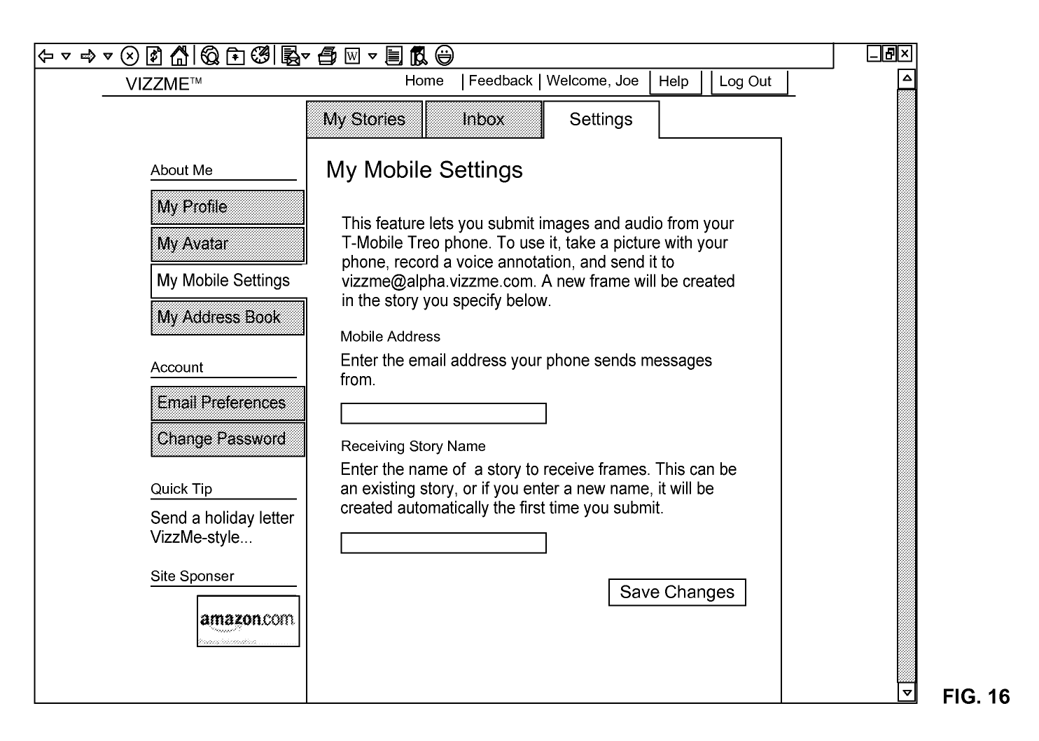

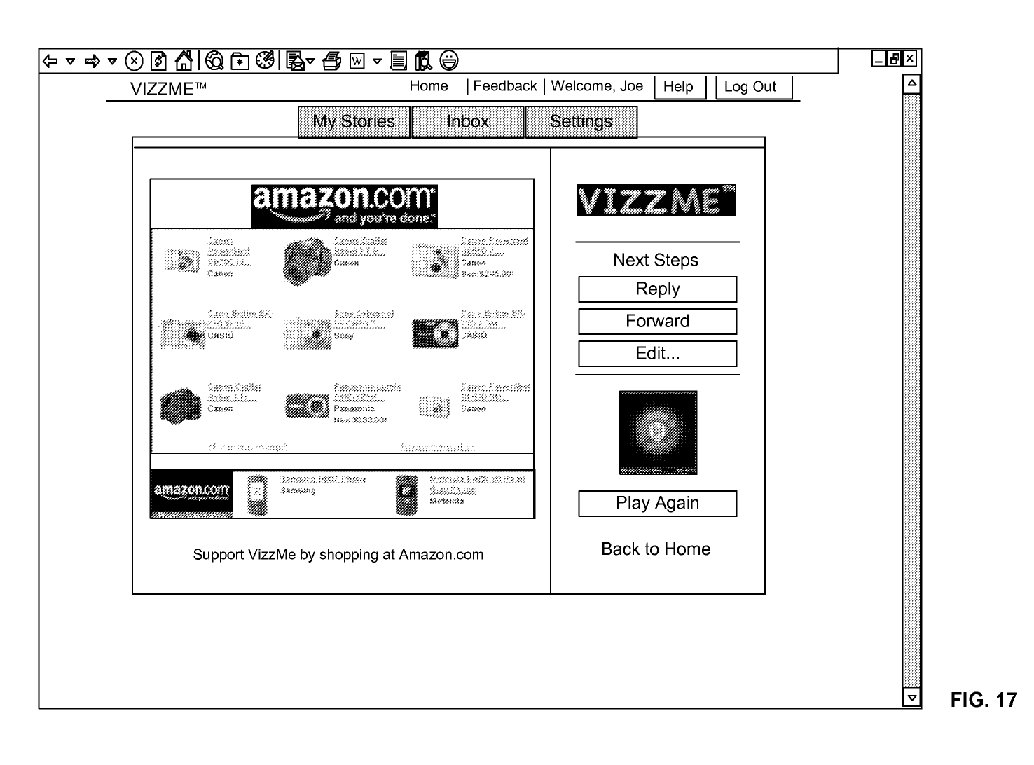

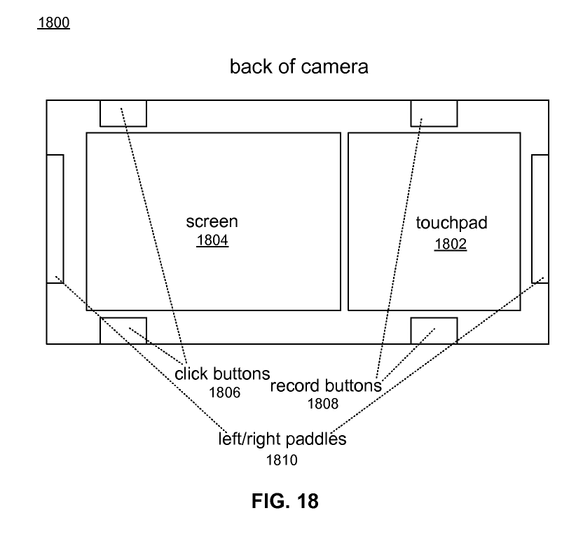

FIG. 10 illustrates the complete structure of a story having a number of different elements. Elements marked (*) are collections of the objects they contain. Only one instance of each item in the collection is shown for brevity. The following sections define each element of the story format shown in FIG. 10 in accordance with a specific embodiment of the invention. For each element, its contents and attributes are described.

According to the depicted embodiment, a story may include a variety of elements including languages, a story name, authors, a watermark, and scene elements. The StoryID attribute is a unique identifier for the story. The Remixable attribute indicates whether the author gives permission for content to be remixed. According to one embodiment, this attribute defaults to true. The DefaultLanguage attribute is a language code for the player to use by default, and is one of the codes listed in the Languages element.

The PlayMode attribute determines how the scenes in the story are played. According to one embodiment, this attribute may be one of the following: Linear—all scenes are played back to back; Loop—same as Linear, but the sequence loops; and Index—viewer selects scene to view from a thumbnail screen. The ApplicationID is an identifier used to implement server actions (described in greater detail with reference to the Action element).

The Languages element contains one or more Language elements, each of which contains text representing the name of the language. The LanguageID attribute is the 2 character language code mentioned above.

The StoryName element contains text representing a name for the story. The xml:Lang attribute is the language code indicating which language applies to this content. The Authors element contains Author elements, each of which contains AuthorName and AuthorImage elements. The AuthorID is a unique identifier for the author. The IsProducer attribute is a Boolean value indicating if this author is the producer (i.e., the owner) of the story. According to a specific embodiment, only one author can be producer; others are assumed to be contributors. The AuthorName element contains text representing the author's name. The AuthorImage element contains a digital image representing the author.

The WatermarkImage contains a digital image (binary data) representing a watermark to be displayed over each frame in the story. The xml:Lang attribute is the language code indicating which language applies to this content.

Scenes contains Scene elements, each of which contains SceneName, SceneSound, and Frames elements. The SceneID is a unique identifier for the scene. The AuthorID attribute is AuthorID of the Author who contributed the scene. The Order attribute is a number indicating the ordinal position of the scene within the story. This is used to determine playback order for stories in the Linear and Loop PlayModes.

The TimingMode attribute indicates how the timing of Frame display is determined. According to a specific embodiment, this attribute may be one of the following: Auto—driven by the length of each frame; Wait—the user advances frames manually; Spread—frames are displayed at even intervals over the length of the scene; and Timeline—frames are displayed according to a timeline giving each frame a specific duration. The Duration attribute is for scenes using Spread or Timeline TimingMode, and sets an absolute duration for the scene. This attribute may be set to: Auto—duration is driven by the scene level audio; and n—absolute duration of n seconds.

The SoundSource attribute indicates which sounds to play during the Scene. According to a specific embodiment, this attribute may be set to one of the following: Frames—play only the audio associated with frames; Scene—play only the audio associated with the scene; Both—play both audio sources simultaneously; and None—don't play any audio at all. The LeadInOutDuration attribute defines the number of seconds to play scene level audio before first frame level audio and after the last frame level audio in the scene (applies to SoundSource=Both). The DefaultFrameDuration attribute defines the number of seconds to display frames whose duration cannot be determined. These or additional attributes may also be used to control fade-in or fade-out of scene and/or frame level audio.

The SceneName element contains text representing a name for the scene. The SceneSound element contains digital audio representing a soundtrack for the entire scene. The xml:Lang attribute for each is the language code indicating which language applies to the content.

Frames contains Frame elements, each of which contains FrameImage (or FrameVideo), FrameCaption, FrameScript, FrameSounds, and Actions elements. The FrameID is a unique identifier for the frame. The AuthorID is the AuthorID of the author of the frame. The Order attribute is a number indicating the ordinal position of the frame within the scene, and is used to determine playback order. The Duration attribute determines how long the frame will display during playback. According to a specific embodiment, this attribute may be set to one of the following: Auto—determine length automatically; and n—a fixed duration of n seconds.

The FrameImage element contains a digital image for the frame. According to a specific embodiment, the frame can specify either a FrameImage or FrameVideo, but not both. If a FrameImage is specified, the CameraMake attribute may be set to specify the brand of camera which took the photo, and the CameraModel attribute to specify the model of camera which took the photo. In addition, the GPSCoordinate attribute may be set to specify the GPS coordinates of the location at which the photo was taken. The xml:Lang attribute is the language code indicating which language applies to this content.

The FrameVideo element contains a digital video file representing the video for the frame. As with the FrameImage element, the CameraMake and CameraModel attribute may be set to specify the brand and model of the camera which took the video. In addition, the GPSCoordinate attribute may be set to specify the GPS coordinates of the location at which the video was shot. The xml:Lang attribute is the language code indicating which language applies to this content.

The FrameCaption element contains text representing either the caption for the frame visual element (i.e., if the frame has an image or video), or a title (i.e., if the frame has no image). The xml:Lang attribute is the language code indicating which language applies to this content.

The FrameScript element contains text representing the script of the audio narration for the Frame. The xml:Lang attribute is the language code indicating which language applies to this content.

The FrameSounds element contains FrameSound, IntroSounds. and OutroSounds elements. The xml:Lang attribute is the language code indicating which language applies to this content. The FrameSound element contains digital audio representing sound to be played in the frame. The AuthorID is the AuthorID of the Author who contributed the audio. The Order attribute specifies a number indicating the ordinal position of the FrameSound within the frame (or within the IntroSounds or OutroSounds groups). This attribute is used to determine the playback order of audio. The IntroSounds and OutroSounds elements also contain FrameSound elements.

The Actions element contains Action elements. The Location attribute indicates where on the playback screen to place the user interface for the Action elements. According to a specific embodiment, this attribute may be set to one of the following: Center, Top, Bottom, Left, and Right. According to a more specific embodiment, further values of this attribute may provide margin” justification to Left/Center/Right once pinpoint position is established. Note that the Location attribute may be ignored on some small form factor players.

Each Action element contains ActionName and ActionImage elements. The ActionID is a unique identifier for the Action. The Order attribute is a number indicating the ordinal position of the Action within the Actions element. The DisplayType attribute indicates if the Action should be rendered using its text name or a custom image. According to a specific embodiment, this attribute may be set to one of the following: Name—render as the ActionName element; or Image—render as the ActionImage element. The ActionType attribute indicates the functionality of the Action. According to a specific embodiment, this attribute may be set to one of the following: Close—closes the player; Next—displays the next Frame; Previous—displays the previous Frame; Scene—jumps to a Scene; and Server—calls a process on a server to enable an arbitrary web service to provide custom functionality.

The ActionName element contains a text string serving as the name of the action. The ActionImage element contains a digital image serving as a visual representation of the action. The xml:Lang attribute is the language code indicating which language applies to this content.

Specific types of actions referred to herein as “server actions” enable a producer to insert a custom feature into a story that the playback application renders as a control, e.g., a button, the viewer can select. Typically, the control calls a service implemented as code on any server accessible via Internet protocols enabling remote procedure calls such as Web Services. Other examples of such controls include, for example, a button in a story describing an item for sale which initiates a bid for that item on an auction web site, and a button in a story acting as an advertisement to request more information from an advertiser.

According to various specific embodiments of the invention, a platform for generating and facilitating playback of stories is provide which includes some or all of the following major concepts. Production is facilitated by a set of tools designed to create stories. Distribution is facilitated by a variety of mechanisms designed to make stories available to viewers. Playback is facilitated by a variety of applications designed for a variety of devices to play story content. Remixing capabilities are provided which enable viewers to reuse content generated by others as their own. Commentary capabilities are provided which enable viewers to share comments and rankings about stories with the authors and other viewers. Account Management tools are provided for members to set their preferences, manage their account, and pay for services. Service Administration tools are provided for the operator of the platform to customize, operate, and manage the services. Integration methods are provided to integrate the various functionalities of the platform with third party sites and services.

The diagram of FIG. 11 illustrates the task of producing stories according to a specific embodiment of the invention. Producer 1102 creates a story 1104 using a consumer level production tool referred to herein as StoryMaker 1106. As shown in the diagram and as will be described, other production tools 1108-1114 for different platforms or purposes are also contemplated. Stories 1104 are stored for the producer in a container called My Stories 1116. Story 1104 includes frames 1118 which the producer can freely add, rearrange, and delete. The producer can optionally invite one or more contributors 1120 to collaborate on the creation of the story. According to some embodiments, contributors are limited to adding new frames (e.g., frame 1122) and audio elements (e.g., audio element 1124) to existing frames. An indicator may be provided to highlight new frames or frames with new audio from contributors.

Following are descriptions of exemplary production tools having different capabilities and functionalities.

StoryMaker is a simple web-based production tool targeted at consumer users. It exposes only a subset of the features described herein to keep the experience as simple as possible. StoryMaker enables the production of simple stories comprising a sequence of frames, each with one or more audio elements (e.g., narrations) from the producer and/or or more contributors. Stories created using StoryMaker are typically single scene, and linear play mode, i.e., multiple scene and nonlinear playback options are hidden from the user. Remixable defaults may be set to true to encourage users to collaborate and share content.

An exemplary story creation flow using StoryMaker will now be described with reference to the web interfaces of FIGS. 12-17. As will be understood, the depicted web application is merely exemplary, and other applications in different computing environments and using different devices are contemplated.

After selecting a story name in the interface of FIG. 12, and as shown in FIG. 13, StoryMaker allows users to upload images either individually or with a batch upload. According to some embodiments, drag and drop may be supported for this. Any of the major image formats (e.g., JPEG, TIFF, BMP, GIF, PNG) may be supported. According to a specific embodiment, a high resolution original may be saved regardless of whether smaller/compressed versions are created for display and playback. According to some embodiments, originals are stored in a standard format (e.g., a max dimension JPEG) to avoid saving very large image files (e.g., a 20 MB TIFF) that might be uploaded. Image rotation, e.g., left and right 90 degrees, may be supported.

As shown in FIG. 14, the user can then record audio using, for example, a computer microphone. StoryMaker allows the user to test the level of the microphone, and then, once an audio clip has been recorded, it is represented in the box at the right which allows the user to review, re-record, delete, and reorder multiple clips. According to a specific embodiment, silence may be automatically trimmed from the beginning and/or end of the recording. According to another embodiment, the volume of each audio clip may be compressed to a normalized level. As mentioned above, StoryMaker allows the user to record different versions of audio clips in different languages for presentation with the same visual content.

As an alternative, or in addition to recording an audio clip, StoryMaker allows the user to upload audio in any of a wide variety of formats (e.g., MP3, WAV, WMA, Quicktime) at any of the frame, scene, and story levels. According to a specific embodiment, a mechanism is provided by which a user may specify “punch-in” and “punch-out” times for a given audio clip so that only a portion of the audio clip (rather than the entire file) is associated with a frame. For example, the user might have an MP3 file of a four minute song, but only want to use 30 seconds of the song. According to this embodiment of the invention, the user may upload the MP3 file, and then specify a punch-in time at 1:00 and a punch-out time at 1:30, thus selecting the corresponding 30 second portion of the uploaded file for association with the frame. According to another embodiment, StoryMaker provides a phone number which users may call to create audio clips for inclusion in a story. Context prompts are provided on the screen of, for example, a mobile device with the phone number and a frame identifier to key into phone.

As an alternative to a still image, StoryMaker allows the user to upload video files to generate frames containing video instead of images. According to one such embodiment, the user is prompted to record an introductory comment which is then followed by the audio from the clip itself. A wide variety of video formats may be supported including various MPEG formats, QuickTime, and any of a variety of video formats created with conventional digital video cameras.

StoryMaker also allows the user to enter a caption for a frame as shown in FIG. 14. In addition, StoryMaker allows the user to enter a script for each frame, i.e., text to serve as a script for the narration to be recorded. The script may also be used to generate content for presentation to people with disabilities. For example, for people with a hearing disability, the script may be used to generate text to display during playback. As another example, for people with a visual disability, computer generated speech may be generated from the caption and or the script for presentation during playback.

Once a sequence of frames has been generated, StoryMaker provides an interface as shown in FIG. 15 which allows the user to manipulate at the frame level including, for example, deleting a frame, and changing the order of the frames (e.g., using a drag and drop operation).

StoryMaker allows a story producer to invite another user to contribute to the story. According to a specific embodiment, the invitation is extended by email to other members of the system who may be selected from a general list of members, or a subset of members, e.g., members who are subscribers to the producer's “channel.” The notion of channel will be discussed below. The email contains a link which, when selected, will result in the story being instantiated for the contributor in StoryMaker. According to a specific embodiment, stories to which a user is a contributor appear in the My Stories list with an indication that they are owned by another user, i.e., the producer. The contributor can delete the story from this list which removes their authorization to edit it, i.e., they would need to be re-invited by the producer for it to reappear.

Contributors can add new frames to a story using all the tools available to a producer. They can delete their own frames, but cannot reorder frames. Contributors can only add additional audio to existing frames.

StoryMaker Pro is a more fully featured production tool intended for professional and “power” users. Unlike the StoryMaker tool, it enables all the features inherent in the story format described above including, for example, Scenes, Timelines, Actions, Watermarks, Intro/Outro Audio, and Professional Workflow. StoryMaker Pro offers all the functionality of StoryMaker plus these extra features. One additional feature is the Story Template which is defined by the Operator and is a starting point for creating stories that have a predefined structure of scenes and placeholder frames. The Professional Workflow features enable different people collaborating on the production of a story to have separate tasks across the story such as, for example, scripting, adding images, roughing in audio, recording real audio, etc.

StoryMaker Mobile is a tool for use with mobile devices, e.g., a mobile camera phone, which enables such devices to create and edit stories. A producer designates a story that will receive story or frame elements, e.g., visual and audio, from the phone. Alternatively, if no story exists, story creation may be initiated from the phone. Story or frame elements may then be submitted by a variety of mechanisms, e.g., Multimedia Messaging Service (MMS), email, or, if the mobile device has web connectivity, the elements may be uploaded directly to a web site using a browser-type functionality. As shown in FIG. 16, StoryMaker Mobile allows the user to select a story via a web interface to receive frames from one or more mobile devices. Depending on the implementation, the visual (still image or video) and audio elements may be uploaded together or separately.

With the emergence of high performance camera phones (including high resolution and high bandwidth capabilities) and the convergence of features in mobile devices generally, embodiments are contemplated in which creating, editing, sending, and playback of a story may be performed in real time from a mobile phone or other similar mobile platform. Such embodiments may also enable identification or selection of an existing story and arranging distribution of the selected story from the mobile device.

According to one set of embodiments, custom applications for mobile platforms may be provided which include any or all of the functionalities of the StoryMaker applications described herein. According to another set of embodiments, standard MMS building blocks may be employed to enable such functionalities. That is, most MMS phones now support picture taking with voice and text annotation with the ability to transmit this information via standard MMS messages. According to a specific embodiment, stories are created and edited by submitting MMS messages to a remote story production platform.

To enable editing, a few simple commands are provided which can be messaged in conjunction with the various media elements. The user makes a story “active” with an Edit command, then manipulates the story with subsequent commands. The commands may be entered into the subject line of the MMS message.

According to a specific embodiment, the command Edit [storyname] either makes the named story active or creates the story if it doesn't exist. The command may also create a frame if media or text elements are attached. Alternatively, a subject line not corresponding to any of the commands creates a frame with the caption being the subject line and using any attached media elements.

The command Change [frame number] replaces the existing frame image and/or audio with the attachments associated with the message. The command Delete [frame number] deletes the identified frame. The command Move [frame number] [new position] moves the identified frame from its current position to the specified new position.

The Play command sends the story back to the producer for playback, e.g., similar to the preview feature in the Web application. The command Send [email addresses and/or phone numbers] sends the story to recipients. For email addresses, the Send command sends the “send story” email described herein, including the body text of the MMS message as the email body text. For phone numbers, the Send command sends the story to the identified phone.

According to some embodiments, the story is rendered into a video format by the remote platform and sent to the mobile devices for playback. According to more specific embodiments, the video format is one that the phones can receive and play without additional client software, e.g., the 3GP format defined by the Third Generation Partnership Project (3GPP) for use on 3G mobile phones.

According to one embodiment, a camera, referred to herein as a StoryCamera, is provided with specific features to create new stories without the use of computer. In addition to typical digital camera features, the StoryCamera has special hardware and software features to facilitate story editing in a small form factor. FIG. 18 illustrates an exemplary hardware design for such a StoryCamera. The back of StoryCamera 1800 is a “thumb operated” story-composing device. This may be achieved, for example, through the use of a touchpad 1802 (similar to those found on laptops) that allows pointing and drag and drop operations of objects displayed on screen 1804. Click buttons 1806 (also similar to those found on laptops) are intended for use by the opposing thumb. Dedicated record buttons 1808 are provided to start and stop recording. “Paddles” 1810 are intended for left to right or back and forth navigation. These could also be pressure sensitive at their top/bottom extremes for up/down navigation. This entire interface is designed to be used left or right handed simply by rotating the camera 180 degrees.

StoryCamera software enables the following functionalities. Some or all of the base features of StoryMaker Mobile may also be available on the StoryCamera and so are not repeated here. The StoryCamera allows users to create, edit, and delete stories directly on the camera. Any image on the camera may be added into a frame. According to one implementation, a mode is provided in which all new shots go into the current story.

Video clips taken with the StoryCamera may be added to frames in a similar manner. Using the record buttons, audio may be recorded for the currently displayed frame. Controls are provided which enable the creation and deletion of frames. Frame order within a story may be changed using, for example, drag and drop enabled by a touchpad and click buttons, and/or click to select and move left or right with paddles.

According to some implementations, stories may be uploaded from the camera to the Web. This may be accomplished in a variety of way. For example, if the camera has web connectivity, the story may be uploaded directly to a web site using a browser-type functionality. Alternatively, the story may be packaged as a file or group of files, downloaded to a computer (over wires or wirelessly), and then uploaded to the Web from the computer.

According to specific embodiments, software (referred to herein as StoryPoint) is provided which is operable to convert audio/visual presentations which are created using other software packages, e.g., Microsoft PowerPoint or Apple Keynote, into stories. According to some embodiments, the StoryPoint software is provided as an addin in the software package for creating the presentations in the original format, i.e., it appears as custom commands and/or features within that application.

According to more specific embodiments, StoryPoint enables two ways of producing stories. In the first way, the user employs the StoryPoint tools to narrate each frame separately to build the story. In the second way, the user captures audio from a live speaker and uses that audio to build the story “post presentation.” To enable the first method, StoryPoint enables the user to record audio for a single frame. That is, for example, a record button could be provided in PowerPoint which records audio for a currently displayed frame. Alternatively, such a record button could be provided which enables the user to record a presenter's entire speech.

According to one embodiment, StoryPoint detects frame advances during the presentation and marks their timing along with the recording. These frame advance timing marks are then proposed as “slice points” for the story. StoryPoint may also allow the user to slice the audio presentation into alternative portions to be assigned to individual frames. Audio could also be recorded separately and imported, allowing the user to assign individual clips to frames, or to slice larger files manually for assignment to frames.

StoryPoint converts the presentation (e.g., a PowerPoint or Keynote presentation) into the story format for later export as a single file, or uploading from within presentation software (e.g., PowerPoint or Keynote) via a web server connection.

FIGS. 19A and 19B illustrate some models for distributing stories according to specific embodiments of the invention. As will be understood, there are many ways to distribute a story, so the exemplary models described should not be construed as limiting the invention. Generally speaking, a producer 1902 selects a story from a My Stories list 1904, and then takes some action to distribute it. Typically, a viewer 1906 receives a pointer to the story rather than a copy of the story itself. Of course, a copy may need to be made for technical reasons. Viewers have an Inbox list 1908 containing pointers to stories that have been sent to them through at least some of the distribution modes. Various aspects of some exemplary modes of distribution are discussed in greater detail below.

According to a specific embodiment, My Stories list 1904 lists the member's stories in either reverse chronological order (e.g., by date last modified like a blog) or alphabetically. Each entry in the list is a story waiting to be edited or published. The following actions can be taken directly or indirectly on each item in the list. The member may edit, duplicate, or delete a story. If the member deletes a story, other members having that story in their Inbox list may be notified. The member may also view comments of other members for stories in the list. The member may also distribute stories from the list using a variety of “send” and “publish” distribution mechanisms described herein.

According to a specific embodiment, Inbox list 1908 lists stories which have been sent to the member, stories to which the member has “subscribed,” or any other stories which have been distributed in some manner to the member. As with My Stories list 1904, the entries in Inbox list 1908 may be presented in reverse chronological order, or alphabetically, e.g., by story name or the names of channels to which the member has subscribed. Each entry in the list is a story waiting to be played, and may include, for example, viewer rating information, a new indicator (i.e., if the viewer has never played story), and an updated indicator (i.e., if the story has been updated since the viewer last played story. The following actions can be taken directly or indirectly on each item in the list. The member may play, remix, remove, or add commentary to stories in the list. The member may also view comments of other members for stories in the list. The member may also link to a My Subscriptions feature which enables the member to manage his subscriptions in the system.

According to one set of embodiments, users are enabled to send a story directly to a Viewer using, for example, a URL embedded in an email message. Selection of the URL displays a landing page from which the story can be played. According to a more specific embodiment, viewers who are members also get the story added to their Inbox list. Viewers who are guests and register to become members before or immediately after watching also get the story added to their Inbox list. Login is not typically required to watch a story distributed this way.

Email addresses for this distribution mode can be manually entered or selected from an address book. According to a specific embodiment, members already “subscribed” to the producer (e.g., channel subscribers, list subscribers, former send recipients) are automatically included in the producer's address book. A separate email is created for each recipient using an email default format customizable by the operator and changeable by the producer at distribution time.

According to a specific embodiment, audience statistics may be viewed for each playback. These statistics may include, for example, the name of the viewer and the time and date of viewing. According to one approach, the email address to which the story was sent is logged as the viewer name, e.g., the email address is logged, a unique ID for the log entry is embedded in the playback URL, and the addressed is looked up when the URL is used.

Advertisements may also be embedded or associated with a story. According to one implementation illustrated in FIG. 17, if the producer's subscription plan indicates ad placement, the ad appears on a final frame along with an end of story remix/comment controls. According to a specific embodiments, tags (defined, for example, by the producer or operator) associated with stories may be mapped to standard categories on the back end in order to target such advertising. For example, the keywords employed by users for tags may be analyzed to determine which ones relate to a particular market segment, e.g., travel. Appropriately targeted advertisements, e.g., travel related ads, may then be placed at the end of stories using those keywords or having similar tags. Embodiments are also contemplated in which a variety of information associated with stories or frames may be evaluated to support this functionality. For example, any text associated with a story or frame may be parsed to identify keywords for serving of advertising content. Such text may include, for example, frame captions, narration scripts, etc. Metadata may also be provided in association with stories and frames to facilitate this functionality. Voice recognition technologies may also be employed to obtain keywords from oral narration.

According to a “publish” distribution mode, the story is put into an invitation-only conduit through which a producer can distribute many stories to many viewers over time. Producers may create one or more “channels” and invite viewers to subscribe. Stories are published into the channel for distribution to subscribed viewers as “StoryCasts,” i.e., a sequence of one or more stories. According to one implementation, each member gets one channel automatically created when they establish their account so those that need only one don't need to figure out how to create one. From the viewer perspective, stories appear in the Inbox list as they are published to channels to which they are subscribed. Email notification of new stories in such channels can be set up by the viewer as an option. Login is preferably required to watch a story published through a channel. According to a specific implementation, StoryCasts are implemented as industry standard RSS feeds.

The publish distribution mode enables the producer to create, rename, and delete one or more channels. The delete function may warn the producer if there are subscribers to the channel designated for deletion. An additional option may also be presented to notify subscribers (e.g., by email) of a channel deletion. Publish and unpublish functionalities are provided by which the producer may post stories to a channel. According to one embodiment, a pricing feature is provided by which the producer may charge subscribers for content. This feature may allow the producer to set a subscription term and amount, or a per story fee.

When a new channel is created, the producer is enabled to invite subscribers to the channel. Members already “subscribed” to the producer (e.g., channel subscribers, list subscribers, former send recipients) may be offered as email addressee options. Email addresses can also be manually entered or selected from an address book. A separate email is created for each recipient using an email default format customizable by the operator and changeable by the producer at distribution time. As with the send mode above, ads may be inserted, and audience statistics may be provided for each playback.

According to one implementation of the publish distribution mode, an invitee gets an email with a URL corresponding to a landing page which enables the invitee to accept or decline the invitation to subscribe. If acceptance is indicated, the invitee is taken directly to what's playing for that channel. If the invitee is not a member, the sign up process may first be facilitated after which the accept/decline landing page is presented without requiring the invitee to navigate there.

According to a specific embodiment, the producer is provided with a My Audience interface to facilitate management of his channels and enable him to invite viewers to subscribe. The following actions can be taken directly or indirectly on each item in the list. The producer may add, rename, or delete channels. According to some embodiments, affected subscribers may be notified of channel deletions. The My Audience interface may provide information regarding the current subscribers to a particular channel or StoryCast. Current stories published to a particular channel or StoryCast may be listed. This might be represented, for example, by a story counter which unfolds to a detailed list. Controls may be provided to enable the producer to invite viewers to subscribe to specific channels, submit (i.e., make public) stories, and set pricing for subscriptions.

Members may be provided with a My Subscriptions interface to enable them to manage their subscriptions. The interface includes a list of current subscriptions and mechanisms by which they can unsubscribe to channels. According to one embodiment, unsubscribing members may remain in a list for possible re-subscription at a later date. Members may also control whether and the manner in which they receive notifications regarding new content in channels to which they have subscribed. Such notifications may take the form of system generated message advising of new story and include a link to the story. An “Inbox” list may also be provided and will be described in greater detail below.

According to a particular implementation, a channel list or directory is provided through which producers can make their channels publicly accessible. Producers may submit channels to the list along with classification information to enable searching and browsing by viewers. Viewers may get stories from the list in a variety of ways. For example, viewers can browse/search the list and play stories directly, and/or select and subscribe to specific channels in the list. Stories played directly do not appear in a viewer's Inbox list. Those obtained through a subscription do.

The list distribution mode allows producers to list their channels using classification information according to a taxonomy and indexing scheme defined by the system operator, or by a user-defined tagging classification scheme (which is now a very common approach to classifying content in web applications). An “unlist” function is also provided. Producers are enabled to set pricing and invite viewers as described above. Additional tools may also be provided by which invitations may be extended to larger audiences (e.g., postings to entire larger member groups). Ads may be inserted and audience statistics viewed as described above.

The list may be navigated and searched by viewers using any of a wide variety of conventional browsing tools. Viewers may accept channel subscription invitations, manage their subscriptions, and select content notification options as described above.

According to a particular set of implementations, a link to a story may be embedded in a third party web site, e.g., an eBay listing, a MySpace profile, or an online dating profile. The producer requests the URL for a specific story and the system provides it in easy to copy format (e.g., no accompanying javascript, etc.). Viewers encountering the link in the third party site may select it and the story may be played directly without going to another site, e.g., the story may be rendered in a pop-up or an embedded window served from a remote server. As with other modes of distribution, audience statistics may be collected and viewed.

According to one class of such embodiments, links to stories are placed as advertisements in the third party sites. According to such embodiments, the producer creates an advertising campaign that defines criteria for placing the ad, its duration, and the budget to run it. A story is published into the campaign, and an ad placement engine distributes the story to third party sites. Viewers that encounter and click on the ad see it play back directly. Viewer statistics may be accumulated and presented. In addition to playbacks (i.e., clickthrough), each ad placement may be logged. Mechanisms may also be provided to track “conversion,” i.e., desirable actions taken by the viewer such as, for example, making a purchase or subscribing to a list.

According to another embodiment, another distribution mode is provided in which a producer can create a publicly accessible story about himself intended to serve as a personal introduction. Each producer is allowed to create a “card,” e.g., a business card or online dating profile, and publish a single story into it. The card defines attributes such as what keywords can be used to locate the card (e.g., phone number, email address, name, handle, etc.). Viewers find cards through a lookup web page. This page initiates playback of the story without disclosing the story's URL in order to prevent large scale scanning of personal information. As with other modes of distribution, audience statistics may be presented and viewed.

According to yet another mode of distribution, a service is provided by which a producer may distribute stories via email en masse, e.g., for direct marketing purposes. Producers create a campaign that defines a distribution list of recipients for the mailing as well as optional merge criteria to alter the story content per recipient, e.g., attributes of each recipient that selectively activate content within the story to better target the message such as, for example, inserting a personalized greeting. A story is published to the distribution list, and a mail merge engine creates the emails with embedded URLs to the story. Viewers that receive the email and click on the URL will see it play back directly. Viewer statistics may be accumulated and presented. In addition to playbacks (i.e., clickthrough), each email sent may be logged. Mechanisms may also be provided to track conversion.

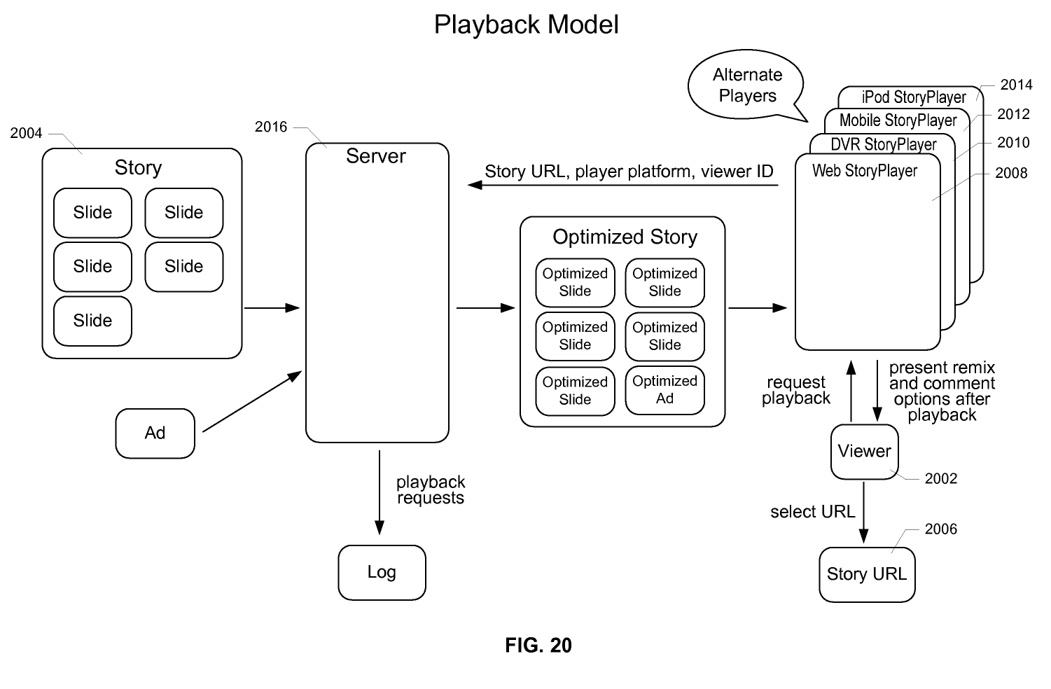

FIG. 20 illustrates models for facilitating playback of stories according to various specific embodiments of the invention. A viewer 2002 selects a story 2004 to play (e.g., by selecting story URL 2006). A playback application (e.g., one of 2008-14) gets the story from server 2016 in a format optimized for the platform on which it is being viewed. As described above, an ad may be inserted into the story for playback. Each playback is logged by the server to facilitate, for example, tracking of audience statistics. After playback, options may be presented to the viewer to remix (e.g., the Edit button) and/or comment (e.g., the Reply button) on the story as shown in FIG. 17.

The following are descriptions of some exemplary playback applications. A Web StoryPlayer (e.g., playback application 2008) plays stories through a web browser. Stories are streamed from the server as requested. The viewer may select the story to play from an Inbox list or a variety of other mechanisms, e.g., a URL in an email, a URL in third party site, a StoryList entry, a StoryCard lookup, etc. For some stories, the viewer may be prompted to select from among a variety of viewer playback options before playback begins. Examples of such options which may be applicable for multiple playback applications are described below.

According to a specific embodiment, if a story has been updated since the viewer last played the story, the user may be advised that one or more new frames have been added to the story, and may even be presented with the option of starting playback at the new frame(s). This might be determined, for example, by comparing the IDs of the frames available during a previous playback with the IDs of the frames available now.

According to various embodiments, the Web StoryPlayer plays a selected story according to Story Playback Rules which may be applicable for multiple playback applications and are described in greater detail below. If a story has embedded actions which call the server, they are processed as invoked by the viewer. After playback, an option may be offered to the viewer to use a commentary feature to provide feedback on the viewing experience (see FIG. 17). Similarly, where permitted by the producer, an option may be offered to the viewer use a remix feature to reuse content from the story as described elsewhere herein. According to a specific implementation, this feature copies the story into the viewer's My Stories list (i.e., not a pointer but a separate copy), and opens in the StoryMaker application for editing.

The Web StoryPlayer may log a variety of playback information including, for example, the date and time of playback, the member ID/name (if the viewer was a logged in member), the viewer email address (if the viewer was a guest), the ID of the last frame viewed (e.g., for resume playback feature), the URL of a site in which the URL of the story is embedded, any technical information available about the platform on which the story is played, e.g., browser type and version, operating system, IP address, etc. As will be understood, this list is not intended to be limiting.

A DVR StoryPlayer (e.g., playback application 2010) plays stories on television via an Internet-connected DVR or other type of set-top box (including those associated with cable and satellite systems). Examples of such set-top boxes include TiVo, cable and satellite providers' proprietary hardware, Microsoft's IPTV platform, and any future devices that connect televisions to the Internet. Depending on the nature of the set-top box, stories may be streamed from the server as requested or downloaded to local storage.

The DVR StoryPlayer enables the viewer to select content to view on the associated TV. According to one implementation, an option may be provided on the Web interface to direct the viewer's Inbox list to the DVR StoryPlayer for presentation on the TV to facilitate selection of stories. This could be accomplished, for example, by matching the DVR's unique identifier to the viewer's account so the user doesn't have to enter their account information in the set-top box. According to a particular embodiment, a “Play all New” feature strings all new stories into one playback. Selection of playback options, play story controls, and processing of embedded actions may be implemented in a manner similar to the Web StoryPlayer, but optimized for presentation on the TV and/or control by the DVR or TV remote control. Stories may also be played by selection of controls in any DVR interface (e.g., in an embedded advertisement) which result in playback as described above with reference to similar Web features.

An analogous commentary feature may also be provided but may be somewhat limited because of the remote control or tailored to take advantage of characteristics of the DVR system itself. For example, in an implementation in a TiVo system, ratings of a particular story could be facilitated using the TiVo thumbs up/down buttons. Playback may be logged in a manner similar to the Web StoryPlayer with some possible exceptions, e.g., email for a guest viewer and embedded URL address are likely not applicable.

The Mobile StoryPlayer (e.g., playback application 2012) plays stories on mobile devices such as, for example, cellular phones, PDA'S, email clients, and other Internet-connected mobile devices with screens. Examples of devices and the corresponding operating systems with which embodiments of the invention may be implemented include Palm OS, Microsoft SmartPhone, Windows Mobile, Blackerry, Symbian, Linux, etc. Stories may be streamed from servers as requested taking into account the available bandwidth when optimizing the content.

According to a specific implementation, story selection is enabled using a version of the viewer's Inbox list optimized for the mobile device. As with the DVR StoryPlayer, this may be enabled by a Web option to direct the Inbox list to mobile device. Selection of a story for playback may also be facilitated by alternative controls presented in the mobile interface including, for example, embedded ads and the like. As with other playback applications, selection of playback options, play story controls, processing of embedded actions, commentary features, and playback logging may be provided but optimized for the mobile device environment.

The Media Player StoryPlayer (e.g., playback application 2014) plays stories on existing portable media players such as, for example, Apple's iPod or any type of MP3 player. Depending on the content model of the media player, stories may need to be synced onto the device and locally stored, e.g., like a podcast. Rendering content to a video format may be suitable depending on the device. Story selection for playback might be enabled, for example, by integration with the media player operating system or firmware. Alternatively, the story content could be rendered and delivered as video that the media player can play natively. Selection of playback options, play story controls, processing of embedded actions, commentary features, and playback (or download) logging may be provided but optimized for the media player environment.

Finally, implementations are contemplated in which a dedicated StoryPlayer appliance is provided. Such an appliance could comprise, for example, a tablet which syncs content in a similar manner to a conventional media player.

The following description refers to the determination and execution of playback rules according to which playback applications designed according to specific embodiments of the invention operate. According to embodiments in which the story format is as described above, and as described in greater detail below, the playback application determines the playback properties of each of the constituent components of the story, i.e., the frame, the scene, and the story itself, and takes into account viewer-controllable options. The playback rules define the standard navigation controls, and the various standard and server actions, as well as what to display after playback completes.

It should be noted that various ones of the elements described below support multiple language versions. That is, if a story includes multiple languages, only the elements with the xml:Lang attribute matching the language selected by the viewer are used. However, if an element does not have an xml:Lang attribute, that element is used no matter what language is selected.

For each frame, the playback application determines three things: (1) Which visual elements should be displayed? (2) What is the audio playlist? (3) What is the playback timing? The answers to these questions depend on a number of attributes of the frame element, the scene that contains it, and the story itself. The following description lays out some exemplary logic for making these determinations.

Which Visual Elements Should Be Displayed? A frame can have up to three visual elements stacked on top each other, the Frame Body, a Watermark, and Actions. The Frame Body is affected by the FrameImage, FrameVideo, and FrameCaption elements of the frame (see Table 1).

TABLE 1

| FrameImage* | FrameVideo* | FrameCaption* | Display |
|---|---|---|---|
| ✓ | — | ✓ | Image with caption |
| ✓ | — | x | Image only |
| — | ✓ | ✓ | Video with caption |
| — | ✓ | x | Video only |
| x | x | ✓ | Title |
| x | x | x | Black |

The Watermark is affected by the WatermarkImage element of the story (see Table 2).

TABLE 2

| WatermarkImage* | Display |
|---|---|
| ✓ | Overlay watermark on top of FrameBody |
| x | (no watermark) |

Actions are affected by the Actions, Action, ActionName, and ActionImage elements of the frame. Placement of the Actions is controlled by the Location attribute of the Actions element and the Order attribute of each Action (see Table 3).

TABLE 3

| | Action | | | |
|---|---|---|---|---|
| Actions | (DisplayType) | ActionName* | ActionImage* | Display |
| ✓ | Name | ✓ | N/A | Button with |
| | | | | ActionName |
| | | | | as button |
| | | | | text |
| ✓ | Image | N/A | ✓ | ActionImage |
| | | | | graphic |
| x | N/A | N/A | N/A | (no actions) |

What is the Audio Playlist? A frame can have one more audio elements play while it is displayed. A “playlist” of audio elements is generated which determines which audio to play and the order in which to play them. The first thing to affect sound at the frame level is the SoundSource attribute of the scene containing the frame. This can turn audio completely on or off for all Frames in the scene (see Table 4)

TABLE 4

| Scene | |
|---|---|
| (SoundSource) | Effect |
| Frames or Both | Frame level audio is switched on |
| Scene or None | Frame level audio is switched off (no playlist) |

That is, if the scene's SoundSource is set to Scene, the playlist for each frame is empty and no further decision making is required.

In the other two cases, the playlist must be determined. This breaks down into two major cases: frames without the IntroSounds and OutroSounds groups (the simple case), and frames with one or both of those groups (the more complex case). In the simple case, a single playlist is generated for the frame. In the complex case, up to three separate playlists may be generated (see Table 5).

TABLE 5

| FrameSounds* | IntroSounds | OutroSounds | Playlists |
|---|---|---|---|
| ✓ | x | x | One playlist consisting of |
| | | | all FrameSounds in the |
| | | | order determined by their |
| | | | respective Order attributes |
| ✓ | ✓ | ✓ | Three playlists-Intro, |
| | | | Main and Outro-each |
| | | | consisting of FrameSounds |
| | | | in the order determined by |
| | | | their respective Order |
| | | | attributes |
| ✓ | ✓ | x | Two playlists-Intro and |
| | | | Main-each consisting of |
| | | | FrameSounds in the order |
| | | | determined by their |
| | | | respective Order attributes |
| ✓ | x | ✓ | Two playlists-Main and |
| | | | Outro-each consisting of |
| | | | FrameSounds in the order |
| | | | determined by their |
| | | | respective Order attributes |
| x | x | x | (no playlists) |

What is the Playback Timing? The final question about a frame is how long to display it. In the case of multiple playlists, additional rules determine the timing of when to play audio. If the frame includes video, alternate rules apply. In the case of a single playlist there are no IntroSounds or OutroSounds resulting in a single playlist for the frame. The major factors affecting playback timing are the TimingMode, SoundSource and DefaultFrameDuration attributes of the scene containing the frame, and the Duration element of the frame itself (see Table 6).

TABLE 6

| | | Frame | |
|---|---|---|---|
| Scene | Scene | (Dura- | |
| (TimingMode) | (SoundSource) | tion) | Playback Rules |
| Auto | Frames or | Auto | Play entire playlist |
| | Both | | sequentially; advance Frame |
| | | | when complete. If playlist is |
| | | | empty, advance frame after |
| | | | Scene's |
| | | | DefaultFrameDuration. |
| | | n | Play entire playlist |
| | | | sequentially; advance Frame |
| | | | after n seconds regardless of |
| | | | whether playlist is complete |
| | | | or not. |
| | Scene or None | Auto | There is no playlist to play in |
| | | | this scenario. Advance the |
| | | | Frame after the Scene's |
| | | | DefaultFrameDuration |
| | | n | There is no playlist to play in |
| | | | this scenario Advance the |
| | | | Frame after n seconds. |
| Wait | Frames or | N/A | Play entire playlist |
| | Both | | sequentially; advance Frame |
| | | | only when user requests. |
| | Scene or None | N/A | There is no playlist to play in |
| | | | this scenario. Advance the |
| | | | Frame only when user |
| | | | requests. |
| Spread | Scene or None | N/A | There is no playlist to play in |
| | | | this scenario. The Scene |
| | | | length is fixed, and each |
| | | | Frame is displayed an equal |
| | | | amount of time to add up the |
| | | | total Scene length (Scene |
| | | | length/# of Frames). More |
| | | | detail how the Scene length |
| | | | is determined in the Scenes |
| | | | section below. |
| Timeline | Scene or None | n | There is no playlist to play in |
| | | | this scenario. The Scene |
| | | | length is fixed, and each |
| | | | Frame is displayed its own |
| | | | Duration n seconds except |
| | | | the last Frame. For that |
| | | | Frame, ignore n and display |
| | | | the Frame until the fixed |
| | | | Scene duration expires. More |
| | | | detail on how the Scene |
| | | | length is determined in the |
| | | | Scenes section below. |

In the case of multiple playlists there are IntroSounds and/or OutroSounds resulting in two or three playlists for the frame. The rules outlined in the table above apply with the addition of the following. In all cases, the multiple playlists will be played in the order Intro→Main→Outro. However, the frame's Duration element affects the timing as follows (see Table 7).

TABLE 7

| Frame | |
|---|---|
| (Duration) | Playback Rules |
| Auto | Play each playlist sequentially (i.e, the three playlists |
| | essentially merge into one) |
| N | Spread the playlists out over n seconds using these rules: |
| | if the total length of all playlists is <n, insert an equal |
| | amount of silence between each list in order to get the total |
| | time to add up to n |
| | if the total length of all playlists is >= n, play each playlist |
| | sequentially (as in Auto or Wait), but cut playback off after |
| | n seconds |

If a frame contains video instead of an image, different variations of the playback model are contemplated. According one alternative, rather than attempting to play narration over the video, video frames play as follows. The audio playlist plays first with the first frame of the video displayed as a still image. When this completes, the video itself is played. If the video has its own audio that may be allowed to play as well. The following outlines scenarios in which video may be embedded in frames, and how the frame advance rules are modified by the inclusion of video (see Table 8).

TABLE 8

| Scene | Scene | Frame | |
|---|---|---|---|
| (TimingMode) | (SoundSource) | (Duration) | Advance Rules |
| Auto | Frames or | Auto | Advance after audio and |
| | Both | | video complete |
| | | n | Advance after n seconds |
| | | | regardless |
| | Scene or None | Auto | Advance after video |
| | | | completes |
| | | n | Advance after n seconds |
| | | | regardless |
| Wait | N/A | N/A | Advance after user requests |

Alternatively, an audio clip, e.g., independently recorded narration, may be played simultaneously with a video either as a substitute or in addition to the audio track associated with the video. In the substitute case, the video and substitute audio may start at the same time and, if the audio is longer, the last frame of the video could remain until the audio completes. On the other hand, if the video is longer, the audio completes while the video continues to play to completion.

The scene determines the playback order for the frames it contains. This is determined by the Order attribute of each frame in the scene. That is, although most playback information is determined at the frame level, some is determined at the scene level. This information includes the scene length (which is an input to calculating Frame duration in the Spread and Timeline TimingModes) and rules for playing scene level audio (see Table 9).

TABLE 9

| Scene | Scene | Scene | | |
|---|---|---|---|---|
| (TimingMode) | (SoundSource) | (Duration) | SceneSound* | Result |
| Auto | Frames or | N/A | N/A | Scene length driven |
| | None | | | entirely by Frame |
| | | | | durations |
| | Scene | N/A | ✓ | Scene length driven |
| | | | | entirely by Frame |
| | | | | durations, but the |
| | | | | SceneSound is played in |
| | | | | the background |
| | | | | while Frame level |
| | | | | audio plays. The |
| | | | | SceneSound loops |
| | | | | continuously until the |
| | | | | Scene completes. |
| | Both | N/A | ✓ | Scene length driven |
| | | | | by Frame durations |
| | | | | and the Scene's |
| | | | | LeadInOutDuration. |
| | | | | The SceneSound is |
| | | | | played in the |
| | | | | background while |
| | | | | Frame level audio |
| | | | | plays, but the first |
| | | | | Frame level audio |
| | | | | waits |
| | | | | LeadInOutDuration |
| | | | | seconds before |
| | | | | starting. The |
| | | | | SceneSound loops |
| | | | | continuously until the |
| | | | | Scene completes, |
| | | | | then continues |
| | | | | LeadInOutDuration |
| | | | | seconds after that |
| | | | | time before stopping. |
| Wait | Frames or | N/A | N/A | There is no scene |
| | None | | | length in this case |
| | | | | because user controls |
| | | | | advance. |
| | Scene | N/A | ✓ | There is no scene |
| | | | | length in this case |
| | | | | because user controls |
| | | | | advance, but |
| | | | | SceneSound is played |
| | | | | in the background |
| | | | | while Frame level |
| | | | | audio plays. The |
| | | | | SceneSound loops |
| | | | | continuously until |
| | | | | audio on the last |
| | | | | Frame completes. |
| | Both | N/A | ✓ | There is no scene |
| | | | | length in this case |
| | | | | because user controls |
| | | | | advance, but |
| | | | | SceneSound is played |
| | | | | in the background |
| | | | | while Frame level |
| | | | | audio plays, but the |
| | | | | first Frame level |
| | | | | audio waits |
| | | | | LeadInOutDuration |
| | | | | seconds before |
| | | | | starting. The |
| | | | | SceneSound loops |
| | | | | continuously until |
| | | | | LeadInOutDuration |
| | | | | seconds after audio |
| | | | | on the last Frame |
| | | | | completes. |
| Spread or | Scene | Auto | ✓ | Scene length equals |
| Timeline | | | | the length the |
| | | | | SceneSound audio. |
| | | | | SceneSound plays |
| | | | | once. |
| | | n | ✓ | Scene length equals |
| | | | | Duration n. The |
| | | | | SceneSound loops |
| | | | | continuously until the |
| | | | | Scene completes. |
| | None | n | N/A | Scene length equals |
| | | | | Duration n. No audio |
| | | | | is played. |

The story determines the manner in which its scenes will be played. According to a specific embodiment, there are three possibilities, all driven by the PlayMode attribute of the Story (see Table 1).

TABLE 10

| Story | |
|---|---|
| (PlayMode) | Playback Rules |
| Linear | Each Scene is played back to back in the sequence |
| | determined by the Order attribute of each Scene element. |
| Loop | same as Linear except the entire sequence repeats |
| | indefinitely until stopped by the viewer |
| Index | The player displays an index page with thumbnails for each |
| | Scene ordered using each one's Order attribute. The |
| | SceneName* for each Scene is used to generate a label |
| | (note this element is subject to the language overlay). |
| | The viewer chooses a Scene to view, and the player returns |
| | to index page after Scene completes. Thumbnails are small |
| | images of the first Frame in each Scene (minus any |
| | Watemark or Actions elements). |

Up to this point, we have been discussing how the story defines its own playback rules. Now, let's consider how the viewer, i.e., the person watching the story, can modify those rules at playback time. The viewer is able to set any or all of the following options before story playback begins: Track Selection; Author Selection; Loop Mode; and Hearing-Impaired Mode.

Track Selection: If the story includes multiple versions, the player application offers the viewer a choice of available versions. As discussed throughout the previous sections, only content matching the selected version (or content which is common to multiple versions) is played. One other issue is the default track of the story. If the viewer does not select a version, the default track becomes the one to use.

Author Selection: The viewer can elect to listen to audio contributions from one or more specific authors which may be stored, for example, in alternate tracks. Examples of this include hearing one of multiple possible narrations, e.g., a parent's narration versus the stock narration of a children's story. Prior to starting playback, the viewer may be given the option of substituting one or more specific authors in the playback. Multiple authors might be selected where, for example, different authors made audio contributions to different frames or even the same frame. The list of authors to display as choices comes from the Authors element within the frame. If a specific author is chosen, only the FrameSound elements with a matching AuthorID attribute are used. Depending on the number of contributors and the manner in which the story is constructed, multiple audio clips from one or more contributors may be presented in a variety of ways. For example, multiple clips may be played as alternatives for the story or a single frame, consecutively in association with a single frame (i.e., multiple authors and/or clips within a single frame), alternately for consecutive frames, etc.

Loop Mode: If the PlaybackMode attribute of a story is set to Linear or Loop, the viewer can override this setting prior to playback. In other words, the viewer can choose if the story should be played back in Linear or Loop mode if it is defined to be either. If the story's PlaybackMode is set to Index, no choice for loop mode is offered. The story will always playback in Index mode.

Hearing-Impaired Mode: A playback mode for hearing-impaired viewers can be set prior to story playback. In this mode, the text content of the Script element of each frame is displayed for the viewer to read. In this mode, frame and/or scene audio may be partially or completely suppressed. In addition, all frames may be set to manual advance mode allowing viewers to read the text at their own pace then advance the frames.

According to various embodiments, a set of navigation controls is provided to enable the viewer to interact with the story as it is playing. These controls rely on a playback sequence having been determined using the rules defined above. These controls may work slightly differently depending on the PlaybackMode.

As described above, in the Linear and Loop modes, there is a single playback sequence for the entire story. In Linear mode, if the viewer lets the entire story play without invoking a navigation control, the story ends with the post-playback screen displayed and all audio terminated. In Loop mode, playback loops until the viewer invokes the End control (see Table 11).

TABLE 11

| Control | Function |
|---|---|
| Next | Advances to the next frame in the playback |
| | sequence. |
| Previous | Returns to the previous frame in the playback |
| | sequence. |
| Pause/Play | Pauses playback (i.e., stops all audio and leaves the |
| | current image displayed). Once paused, invoking this |
| | control again resumes playback. |
| Audio Selector | While paused, allows independent selection and |
| | playback of different audio clips on the same Frame |
| End | Stops playback completely and displays the post- |
| | playback screen |
| Replay | Restarts playback at the beginning of the story. |

In Index mode, there is a playback sequence for each scene and an index page from which the viewer plays scenes. While the index page is displayed, no navigation controls have to be displayed. That is, since these controls are intended to control a playback sequence, they have no function until a scene playback is requested. Once a scene starts, the controls become available. If the viewer lets the entire scene play without invoking a navigation control, the scene ends by returning to the index page (see Table 12).

TABLE 12

| Control | Function |
|---|---|
| Next | Advances to the next frame in the playback |
| | sequence. |
| Previous | Returns to the previous frame in the playback |
| | sequence. |
| Pause/Play | Pauses playback (i.e., stops all audio and leaves the |
| | current image displayed). Once paused, invoking this |
| | control again resumes playback. |
| Audio Selector | While paused, allows independent selection and |
| | playback of different audio clips on the same Frame |
| Index | Returns to the index page. |
| Replay | Restarts playback at the beginning of the Scene. |

A manual advance mode is also contemplated in which the viewer manually advances through the story frame by frame. In this mode, the viewer needs to take some action (e.g., select “Next”) to advance to the next frame, but does not need to do anything to halt the presentation at the end of each frame, i.e., an automatic pause. Such a viewing mode could be advantageous, for example, for presentations representing step-by-step instructions for performing a task, e.g., a cooking presentation.

The types of Actions that can appear on frames and how they are rendered visually is described above. The following table describes the functionality provided by each (see Table 13).

TABLE 13

| ActionType | Function |
|---|---|
| Close | Closes the player application |
| Next | Performs same function as Next navigation control |
| Previous | Performs same function as Previous navigation |
| | control |
| Scene | Jumps to the Scene indicated the SceneID attribute. |
| | In Index mode, this has the same effect as using the |
| | index page to jump to a Scene. In the other modes, |
| | this is jumping to a new frame in the Story playback |
| | order. Playback will continue linearly from that |
| | point. |
| Server | Sends the following parameters to a process on the |
| | server so that process can call an arbitrary web |
| | service to provide custom functionality: |
| | StoryID |
| | SceneID |
| | FrameID |
| | ActionID |
| | ApplicationID (attribute of Story) |

As mentioned above, after playback concludes, the playback application may display a final screen which may include a “close” button to terminate operation of the playback application. A “remix” button may be displayed if the story is designated as remixable, i.e., by the story owner. A comment button may be displayed, for example, depending on the distribution mode of the story, e.g., whether the story was delivered through a channel, a list, or a send. Rating buttons may similarly be displayed. An advertisement may be displayed.

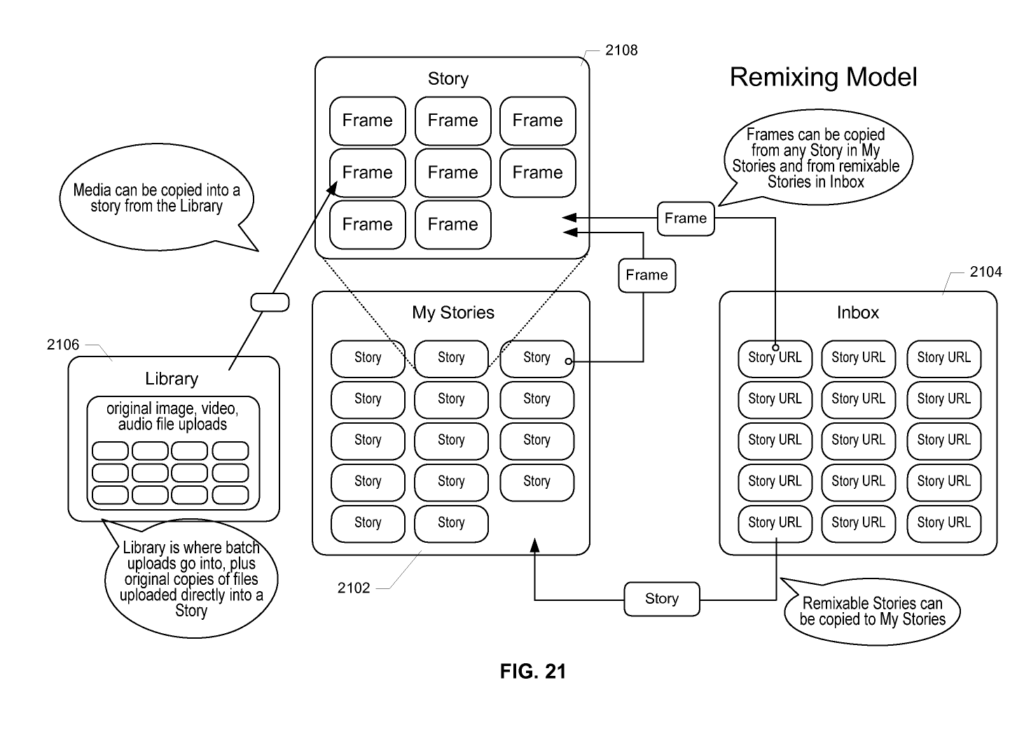

FIG. 21 illustrates model for facilitating remixing of story content according to various specific embodiments of the invention. As used herein, “remixing” relates to building a new story by taking frames from other stories. Once taken, a frame is copied into the new story and can be changed (e.g., new audio recorded) without affecting the original frame. Frames may be copied, for example, from stories in My Stories list 2102, and stories in Inbox list 2104 that have been marked as “remixable” by their respective producers. According to one embodiment, the default for this parameter is to allow remixing unless set otherwise by the producer or owner.

A viewer can also copy an entire story marked as “remixable” from Inbox 2104 to My Stories 2102, in effect taking a snapshot of that story, and breaking any dependence to the version which was copied. A “remix” control may be provided at the end of story playback (described above) which facilitates copying of the story and opening it in the StoryMaker. This serves as both a highly visible shortcut to promote remixing as well as a way to eliminate stories a viewer wants to remix from disappearing from Inbox 2104 at a later date (e.g., if deleted by the producer).

The “New Frame” feature in StoryMaker enables the user to get frames from My Stories 2102 and Inbox 2104 as described above. A Library 2106 is provided to store uploads of images, video, and audio not uploaded directly into a story as well as copies of items uploaded directly into a story. That is, regardless of how they are uploaded, a member's content objects are stored in Library 2106. Library 2106 may also store entire frames and scenes thereby enabling the reuse of higher level story objects. As a member produces stories or story object outside the context of a story, all of the various associated objects may be stored (either automatically or manually) in Library 2106. Any objects in Library 2106 can be copied from Library 2106 into a story (e.g., story 2108) as it is being produced. According to specific embodiment, Library 2106 stores the original unaltered file, while the versions in the story are copies which may be optimized in some way (e.g., converted, compressed, or resized) to suit the particular playback application or device for which the story is intended.

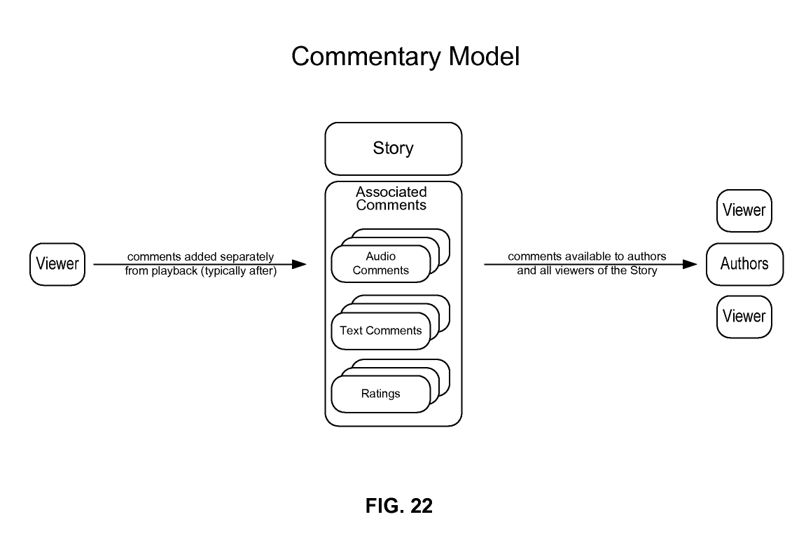

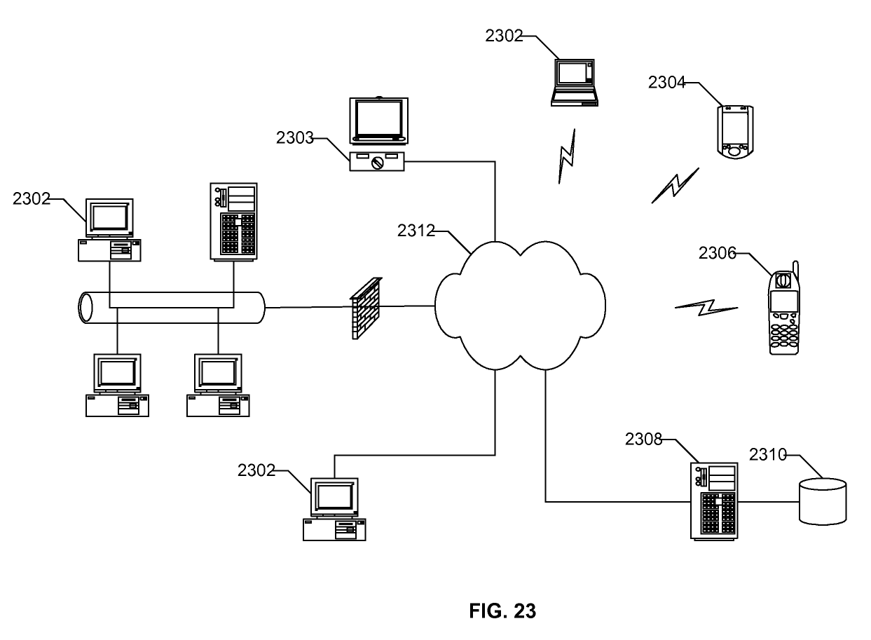

FIG. 22 illustrates model for adding and playing commentary regarding a story according to various specific embodiments of the invention. Comments can be added by any viewer at any time, but are typically added after story playback, at which point a comment option may be presented. According to a specific embodiment, comments apply to the story as a whole rather than individual frames within it. However, embodiments are contemplated in which frame level comments are enabled. Comments do not become part of the story, but are instead about the story, i.e., they are generally experienced separately from story playback. Comments may be directed to the producer or publisher of a story, or to an entire community, e.g., all members subscribing to a particular channel, or a group of individuals selected by the person posting the commentary.

According to one implementation, three types of comments are available. The commenter may record a narrative comment using, for example, a record interface and microphone similar to the one described above with reference to story production. Alternatively, audio commentary may be posted using a variety of mechanisms, e.g., uploading an audio file, or calling in the commentary using a phone to a number provided by the system. A wide variety of suitable alternatives will be apparent to those of skill in the art. A commenter may also enter a text comment using any suitable text input interface. According to a specific embodiment, if a URL is entered as part of the text comment, it is displayed as a selectable link when the comment is viewed. Finally, a commenter may be enabled to rate a story using any of a wide variety of rating systems, e.g., one to five star rating of the story.

Commentary may be viewed by the story producer and other viewers. According to a specific embodiment, an average rating for a story and a listing of all comments associated with the story is made available for viewers in the Inbox list, and for the producer in the My Stories list.

According to various embodiments, a variety of account management tools are provided to enable members to set their preferences, manage their accounts, and pay for services. Login functionalities include account creation which enables guests to convert to members, secure log in (e.g., using SSL), and conventional password features. Users are able to maintain a profile including contact information, billing information, and email preferences. According to some embodiments, the user is able to elect whether or not to receive notification of new/updated stories (default yes), accepted/declined invitations (default yes), new features and services, etc. The user may also upload a personal photo for display as an icon in frames of his or her stories as well as to associate with commentary on other stories. A selection of images may be provided to the user as an alternative.

Account statements may also be provided with which a user may track various financial aspects of the system. For example, a detailed report of charges for services may be provided in a monthly statement format. A user may also earn and view credits resulting from a new member joining as result of a referral from the user. A producer may view revenue resulting from viewers paying for access to the producer's content. Similarly, a producer may view ad revenue from a split of revenue from ads placed in the producer's content.

A variety of backup functionalities may also be provided. For example, an export story tool may be provided to export the entire content of a story in a particular format where the original images and audio are maintained as accessible in standard formats. In addition, a service may be provided which enables delivery of some or all a producer's stories on physical media in a format where original images/audio are in standard formats and easy to find.

According to one class of embodiments, a federated model is contemplated in which different instances of the platform described herein are run by different operators but are able to exchange some types of information. For example, according to one such embodiment, users are able to subscribe to content hosted on other instances and see it in the Inbox list on their own instance. According to some embodiments, remixing of stories and story objects is supported across federated instances. For example, User A's has an account with an instance on Server 1 and sends a story to User B who has an account with a different instance on Server 2. According to a specific embodiment, User B may remix User A's story (assuming User A's permission), in which case Server 2 communicates with Server 1 to copy the story across the network to Server 2 on User B's behalf. This operation is typically transparent to both users.

According to specific embodiments, a variety of functionalities may be provided to enable the monitoring and management of content. For example, mechanisms may be provided to enable viewers to report offensive content in publicly available stories to the operator, and to enable the operator to review any story on the platform. Tools may also be provided by which such content could be flagged for possible removal, and removed where deemed appropriate.

A variety of billing functionalities may also be provided in platforms designed according to the present invention. For example, operators may set billing policies and pricing for various services according to one or more pricing models, and communicate such policies and pricing to members in, for example, price lists. Billing functionalities enable the operator to charge for services according to their established policies, e.g., each member has credit card on file to which charges are accumulated and billed on a periodic basis. If a free trial is enabled as one such billing policy, mechanisms are provided to suspend accounts of members past the trial period and encourage conversion, e.g., web redirection page, or by email notification.

According to a specific embodiment, a platform enabling the creation and distribution of stories is designed around the XHTML/CSS standards to enable some or all of a wide variety of features and advantages including, for example, rapid redesign, maximum browser compatibility, fast page loads, lower bandwidth requirements, mobile device support, and hearing impaired navigation. For additional background discussion, please refer to Designing With Web Standards by Jeffrey Zeldman, the entire disclosure of which is incorporated herein by reference for all purposes. It should be noted that while implementation according to this family of standards may be advantageous for particular implementations, embodiments of the invention may be implemented using a wide variety of software tools and programming languages without departing from the scope of the invention.

According to a specific embodiment, StoryMaker has an API which enables the development of story production applications against a consistent programming model. Examples of such application include plugins for third party applications or sites, e.g., iPhoto, PowerPoint, etc., a StoryCamera as described above, or even tools authored by third parties. The StoryMaker API may include any of the following functionalities. An authenticate functionality allows the application to authenticate its user as a member. Similarly, a “create new user” functionality allows the application to make its user a member. A “get story list” functionality gets the member's My Stories list to enable selection of a story to edit. A download functionality enables downloads of story media and meta data for editing directly in the application. An upload functionality uploads a completed story to the story platform. The API may also support a functionality to request HTML code to link or embed a given story. This enables a third party site to build a tool to insert embedded stories directly into their site.

According to some embodiments, RSS feeds may be used as a mechanism to subscribe to story channels. Such an approach enables third parties to “mash” story content into their own applications. This also enables an Inbox list to get stories from services run by different operators. According to specific embodiments, producers can elect to turn feeds on or off for their channels. For invite only channels, viewers may authenticate through an RSS feed. For more information on RSS feeds, refer to
http://www.feedburner.com/fb/a/aboutrss.

While the invention has been particularly shown and described with reference to specific embodiments thereof, it will be understood by those skilled in the art that changes in the form and details of the disclosed embodiments may be made without departing from the spirit or scope of the invention. For example, it should be noted that aspects of the present invention may be implemented on any of a wide variety computing platforms, in any of a wide variety of network types and topologies, and using any of a wide variety of software tools and programming languages. For example as described above, and as illustrated in FIG. 23, implementations are contemplated in which the techniques for producing, distributing, and playback of multimedia presentations described herein are enabled on personal computers 2302, media computing platforms 2303 (e.g., gaming platforms, or cable and satellite set top boxes with navigation and recording capabilities), handheld computing devices (e.g., PDAs) 2304, cell phones 2306, or any other type of portable communication platform. The various process and related interfaces enabled by the present invention may be resident on such devices, e.g., as part of a browser or other application, be served up from a remote site, e.g., in a Web page, (represented by server 2308 and data store 2310), or be facilitated by one or more devices working together. The invention may also be practiced in a wide variety of network environments (represented by network 2312), e.g., TCP/IP-based networks, cable networks, telecommunications networks, wireless networks, etc.

In addition, the story format described herein, and the techniques for producing and distributing stories may be applied to a wide variety of markets. Personal storytelling applications of the present invention are characterized by stories being produced by individuals on their own behalf, e.g., informal story telling, as an alternative to simple photo sharing, social networking, etc. Professional storytelling applications are characterized by stories being produced professionally for the purpose of entertainment, education and training, and information, e.g., children's stories, comic books and graphic novels, formal education, physical and exercise training, etc. Business storytelling applications are characterized by stories being produced professionally for the purpose of business, marketing, or other organizational needs, e.g., advertising, product information, direct marketing, fundraising, business presentations, political activism, etc. Third party integration applications are characterized by stories being added as a feature within a third party operated site or service, e.g., social networking (e.g., online dating), community commerce, professional resumes, real estate, etc.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for generating a multimedia presentation, comprising:
presenting first interfaces operable by a first user to associate visual objects with frame objects;
presenting second interfaces operable by the first user to associate audio objects with the frame objects; and
presenting a third interface operable by the first user to manipulate the frame objects and to thereby modify a presentation object corresponding to a sequence of the frame objects, manipulation of each frame object resulting in corresponding manipulation of the associated visual and audio objects;
wherein the first, second, and third interfaces are together operable to facilitate configuration of the presentation object, the frame objects, and the visual and audio objects in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

2. The method of claim 1 wherein the second interfaces are further operable by the user to associate multiple ones of the audio objects with a first one of the frame objects.

3. The method of claim 2 wherein the multiple audio objects comprise one or more of different language versions of similar content, or different content versions intended for different audiences.

4. The method of claim 2 wherein instantiation of the first frame object results in one of instantiation of only one of the multiple associated audio objects, or sequential instantiation of the multiple associated audio objects.

5. The method of claim 2 wherein the first frame object includes a plurality of tracks each of which corresponds to one of the multiple associated audio objects, the first frame object also having only a first one of the visual objects associated therewith, the first visual object being associated with only a first one of the tracks, wherein instantiation of the first frame object in accordance with any one of the tracks results in presentation of the first visual object.

6. The method of claim 1 wherein interaction by the first user with at least some of the interfaces results in association of an image corresponding to the first user with selected ones of the audio objects such that the first user image is displayed during portions of the multimedia presentation corresponding to the selected audio objects.

7. The method of claim 1 further comprising presenting fourth interfaces operable by a collaborating user to associate additional audio objects with selected ones of the frame objects.

8. The method of claim 7 wherein interaction by the collaborating user with the fourth interfaces results in association of an image corresponding to the collaborating user with the additional audio objects such that the collaborating user image is displayed during portions of the multimedia presentation corresponding to the additional audio objects.

9. The method of claim 1 wherein the first and second interfaces are operable by the first user to associate the visual and audio objects with the frame objects by one or more of facilitating generation of new objects or facilitating selection of preexisting objects.

10. The method of claim 1 wherein at least some of the first and second interfaces are operable by the first user to enter text for association with selected ones of the frame objects such that the text is displayed during portions of the multimedia presentation corresponding to the selected frame objects.

11. The method of claim 10 wherein a first one of the selected frame objects does not have an associated visual object, and wherein instantiation of the first selected frame object results in display of the text associated with the first selected frame object in a location where the visual objects are otherwise displayed with other frames.

12. The method of claim 10 wherein a first one of the selected frame objects has a first one of the audio objects associated therewith, the first audio object corresponding to a voice recording made by the first user, and wherein the text associated with the first selected frame object comprises a script corresponding to the voice recording.

13. The method of claim 1 wherein the visual objects comprise one or more of video files, image files, or animation files.

14. The method of claim 1 further comprising:
enabling the first user to designate one or more of the presentation object, the frame objects, the visual objects, or the audio objects as reusable by other users; and
presenting fourth interfaces operable by a second user to produce a second multimedia presentation using one or more of the designated ones of the presentation object, the frame objects, and the visual and audio objects.

15. The method of claim 1 further comprising presenting at least one fourth interface operable by the first user to associate each of a plurality of subsets of the frame objects with one of a plurality of scene objects, each of the scene objects representing a different branch of the multimedia presentation, wherein instantiation of the presentation object results in alternate instantiation of the scene objects.

16. The method of claim 1 further comprising presenting a fourth interface operable by the first user to associate a control object with a first one of the frame objects such that the control object is presented during the multimedia presentation in conjunction with instantiation of the first frame object, the control object being operable to call a remote process.

17. The method of claim 1 further comprising presenting a fourth interface operable by the first user to facilitate association of advertising content with one or more of the presentation object, the frame objects, and the visual and audio objects, such that the advertising content is presented in conjunction with presentation of the multimedia presentation.

18. A computer program product for generating a multimedia presentation, the computer program product comprising at least one computer-readable medium having computer program instructions stored therein operable to cause at least one computer to:
present first interfaces operable by a first user to associate visual objects with frame objects;
present second interfaces operable by the first user to associate audio objects with the frame objects; and
present a third interface operable by the first user to manipulate the frame objects and to thereby modify a presentation object corresponding to a sequence of the frame objects, manipulation of each frame object resulting in corresponding manipulation of the associated visual and audio objects;
wherein the first, second, and third interfaces are together operable to facilitate configuration of the presentation object, the frame objects, and the visual and audio objects in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

19. The computer program product of claim 18 wherein the second interfaces are further operable by the user to associate multiple ones of the audio objects with a first one of the frame objects.

20. The computer program product of claim 19 wherein the multiple audio objects comprise one or more of different language versions of similar content, or different content versions intended for different audiences.

21. The computer program product of claim 19 wherein instantiation of the first frame object results in one or more of instantiation of only one of the multiple associated audio objects, or sequential instantiation of the multiple associated audio objects.

22. The computer program product of claim 19 wherein the first frame object includes a plurality of tracks each of which corresponds to one of the multiple associated audio objects, the first frame object also having only a first one of the visual objects associated therewith, the first visual object being associated with only a first one of the tracks, wherein instantiation of the first frame object in accordance with any one of the tracks results in presentation of the first visual object.

23. The computer program product of claim 18 wherein interaction by the first user with at least some of the interfaces results in association of an image corresponding to the first user with selected ones of the audio objects such that the first user image is displayed during portions of the multimedia presentation corresponding to the selected audio objects.

24. The computer program product of claim 18 wherein the computer program instructions are further operable to cause at least one computer to present fourth interfaces operable by a collaborating user to associate additional audio objects with selected ones of the frame objects.

25. The computer program product of claim 24 wherein interaction by the collaborating user with the fourth interfaces results in association of an image corresponding to the collaborating user with the additional audio objects such that the collaborating user image is displayed during portions of the multimedia presentation corresponding to the additional audio objects.

26. The computer program product of claim 18 wherein the first and second interfaces are operable by the first user to associate the visual and audio objects with the frame objects by one or more of facilitating generation of new objects or facilitating selection of preexisting objects.

27. The computer program product of claim 18 wherein at least some of the first and second interfaces are operable by the first user to enter text for association with selected ones of the frame objects such that the text is displayed during portions of the multimedia presentation corresponding to the selected frame objects.

28. The computer program product of claim 27 wherein a first one of the selected frame objects does not have an associated visual object, and wherein instantiation of the first selected frame object results in display of the text associated with the first selected frame object in a location where the visual objects are otherwise displayed with other frames.

29. The computer program product of claim 27 wherein a first one of the selected frame objects has a first one of the audio objects associated therewith, the first audio object corresponding to a voice recording made by the first user, and wherein the text associated with the first selected frame object comprises a script corresponding to the voice recording.

30. The computer program product of claim 18 wherein the visual objects comprise one or more of video files, image files, or animation files.

31. The computer program product of claim 18 wherein the computer program instructions are further operable to cause at least one computer to:
enable the first user to designate one or more of the presentation object, the frame objects, the visual objects, or the audio objects as reusable by other users; and
present fourth interfaces operable by a second user to produce a second multimedia presentation using one or more of the designated ones of the presentation object, the frame objects, and the visual and audio objects.

32. The computer program product of claim 18 wherein the computer program instructions are further operable to cause at least one computer to present at least one fourth interface operable by the first user to associate each of a plurality of subsets of the frame objects with one of a plurality of scene objects, each of the scene objects representing a different branch of the multimedia presentation, wherein instantiation of the presentation object results in alternate instantiation of the scene objects.

33. The computer program product of claim 18 wherein the computer program instructions are further operable to cause at least one computer to present a fourth interface operable by the first user to associate a control object with a first one of the frame objects such that the control object is presented during the multimedia presentation in conjunction with instantiation of the first frame object, the control object being operable to call a remote process.

34. The computer program product of claim 18 wherein the computer program instructions are further operable to cause at least one computer to present a fourth interface operable by the first user to facilitate association of advertising content with one or more of the presentation object, the frame objects, the visual objects, or the audio objects, such that the advertising content is presented in conjunction with presentation of the multimedia presentation.

35. A computer-implemented method for facilitating playback of a multimedia presentation, comprising instantiating a presentation object representing a sequence of frame objects, each of the frame objects having associated visual and audio objects, wherein the presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

36. The method of claim 35 wherein instantiation of the presentation object results in presentation of the multimedia presentation on a device, the method further comprising controlling instantiation of one or more of the presentation object, the frame objects, the visual objects, or the audio objects to optimize the multimedia presentation for the device.

37. The method of claim 36 wherein the device comprises one of a desktop computer, a laptop computer, a handheld telecommunications device, a personal digital assistant, an email client, a digital appliance, or a set-top box.

38. The method of claim 35 wherein instantiation of the presentation object results in presentation of the multimedia presentation to a viewer, the method further comprising presenting a first interface operable by the viewer to provide feedback regarding the multimedia presentation.

39. The method of claim 35 wherein instantiation of the presentation object results in presentation of the multimedia presentation to a plurality of viewers, the method further comprising presenting a first interface operable by a producer of the multimedia presentation to view information relating to the plurality of viewers.

40. The method of claim 35 wherein instantiation of the presentation object results in presentation of the multimedia presentation to a viewer, the method further comprising capturing events representing interaction of the viewer with the multimedia presentation.

41. The method of claim 35 wherein instantiation of the presentation object results in presentation of the multimedia presentation to a viewer, and wherein one or more of the presentation object, the frame objects, the visual objects, or the audio objects are designated as reusable by other users, the method further comprising presenting a first interface to the viewer facilitating reuse of selected ones of the designated ones of the presentation object, the frame objects, the visual objects, or the audio objects in producing a second multimedia presentation.

42. The method of claim 35 wherein a first one of the frame objects has multiple ones of the audio objects associated therewith, and wherein instantiation of the first frame object results in one of instantiation of only one of the multiple associated audio objects, or sequential instantiation of the multiple associated audio objects.

43. The method of claim 35 wherein a first one of the frame objects has multiple ones of the audio objects associated therewith, and wherein the multiple audio objects comprise one or more of different language versions of similar content, or different content versions intended for different audiences.

44. The method of claim 35 wherein a first one of the frame objects has multiple ones of the audio objects associated therewith, and wherein the first frame object includes a plurality of tracks each of which corresponds to one of the multiple associated audio objects, the first frame object also having only a first one of the visual objects associated therewith, the first visual object being associated with only a first one of the tracks, wherein instantiation of the first frame object in accordance with any one of the tracks results in presentation of the first visual object.

45. The method of claim 35 wherein a first user is associated with production of the multimedia presentation, and wherein an image corresponding to the first user is associated with first selected ones of the audio objects such that the first user image is displayed during portions of the multimedia presentation corresponding to the first selected audio objects.

46. The method of claim 45 wherein a second user is associated with production of the multimedia presentation, and wherein an image corresponding to the second user is associated with second selected ones of the audio objects such that the second user image is displayed during portions of the multimedia presentation corresponding to the second selected audio objects.

47. The method of claim 46 wherein one of the first selected audio objects and one the second selected audio objects are associated with a first one of the frame objects such that both images are displayed during a portion of the multimedia presentation corresponding to the first frame object.

48. The method of claim 35 wherein each of a plurality of subsets of the frame objects is associated with one of a plurality of scene objects, each of the scene objects representing a different branch of the multimedia presentation, wherein instantiation of the presentation object results in alternate instantiation of the scene objects.

49. The method of claim 35 wherein a control object is associated with a first one of the frame objects such that the control object is presented during the multimedia presentation in conjunction with instantiation of the first frame object, the control object being operable to call a remote process.

50. A computer-program product for facilitating playback of a multimedia presentation, the computer program product comprising at least one computer-readable medium having computer program instructions stored therein operable to cause at least one computer to instantiate a presentation object representing a sequence of frame objects, each of the frame objects having associated visual and audio objects, wherein the presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

51. The computer program product of claim 50 wherein instantiation of the presentation object results in presentation of the multimedia presentation on a device, and wherein the computer program instructions are further operable to cause at least one computer to control instantiation of one or more of the presentation object, the frame objects, the visual objects, or the audio objects to optimize the multimedia presentation for the device.

52. The computer program product of claim 51 wherein the device comprises one of a desktop computer, a laptop computer, a handheld telecommunications device, a personal digital assistant, an email client, a digital appliance, or a set-top box.

53. The computer program product of claim 50 wherein instantiation of the presentation object results in presentation of the multimedia presentation to a viewer, and wherein the computer program instructions are further operable to cause at least one computer to present a first interface operable by the viewer to provide feedback regarding the multimedia presentation.

54. The computer program product of claim 50 wherein instantiation of the presentation object results in presentation of the multimedia presentation to a plurality of viewers, and wherein the computer program instructions are further operable to cause at least one computer to present a first interface operable by a producer of the multimedia presentation to view information relating to the plurality of viewers.

55. The computer program product of claim 50 wherein instantiation of the presentation object results in presentation of the multimedia presentation to a viewer, and wherein the computer program instructions are further operable to cause at least one computer to capture events representing interaction of the viewer with the multimedia presentation.

56. The computer program product of claim 50 wherein instantiation of the presentation object results in presentation of the multimedia presentation to a viewer, and wherein one or more of the presentation object, the frame objects, the visual objects, or the audio objects are designated as reusable by other users, and wherein the computer program instructions are further operable to cause at least one computer to present a first interface to the viewer facilitating reuse of selected ones of the designated ones of the presentation object, the frame objects, the visual objects, or the audio objects in producing a second multimedia presentation.

57. The computer program product of claim 50 wherein a first one of the frame objects has multiple ones of the audio objects associated therewith, and wherein instantiation of the first frame object results in one of instantiation of only one of the multiple associated audio objects, or sequential instantiation of the multiple associated audio objects.

58. The computer program product of claim 50 wherein a first one of the frame objects has multiple ones of the audio objects associated therewith, and wherein the multiple audio objects comprise one or more of different language versions of similar content, or different content versions intended for different audiences.

59. The computer program product of claim 50 wherein a first one of the frame objects has multiple ones of the audio objects associated therewith, and wherein the first frame object includes a plurality of tracks each of which corresponds to one of the multiple associated audio objects, the first frame object also having only a first one of the visual objects associated therewith, the first visual object being associated with only a first one of the tracks, wherein instantiation of the first frame object in accordance with any one of the tracks results in presentation of the first visual object.

60. The computer program product of claim 50 wherein a first user is associated with production of the multimedia presentation, and wherein an image corresponding to the first user is associated with first selected ones of the audio objects such that the first user image is displayed during portions of the multimedia presentation corresponding to the first selected audio objects.

61. The computer program product of claim 60 wherein a second user is associated with production of the multimedia presentation, and wherein an image corresponding to the second user is associated with second selected ones of the audio objects such that the second user image is displayed during portions of the multimedia presentation corresponding to the second selected audio objects.

62. The computer program product of claim 61 wherein one of the first selected audio objects and one the second selected audio objects are associated with a first one of the frame objects such that both images are displayed during a portion of the multimedia presentation corresponding to the first frame object.

63. The computer program product of claim 50 wherein each of a plurality of subsets of the frame objects is associated with one of a plurality of scene objects, each of the scene objects representing a different branch of the multimedia presentation, wherein instantiation of the presentation object results in alternate instantiation of the scene objects.

64. The computer program product of claim 50 wherein a control object is associated with a first one of the frame objects such that the control object is presented during the multimedia presentation in conjunction with instantiation of the first frame object, the control object being operable to call a remote process.

65. A platform for facilitating generation of a plurality of multimedia presentations by a plurality of users, comprising at least one computing device configured to implement:
a production process for generating the multimedia presentations, each of the multimedia presentations comprising visual objects and audio objects configured as a plurality of frame objects, the frame objects being further configured as a sequence represented by a presentation object, wherein the presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation; and
at least one distribution process for facilitating playback of the multimedia presentations by the plurality of users.

66. The platform of claim 65 wherein the distribution process comprises a send process operable to transmit a communication referring to a first one of the multimedia presentations to one or more viewers, thereby enabling the one or more viewers to play the first multimedia presentation.

67. The platform of claim 65 wherein the distribution process is operable to present a list including selected ones of the multimedia presentations to each of the users, the distribution process comprising a send process operable to insert an entry corresponding to the first multimedia presentation in the lists corresponding to selected ones of the users, thereby enabling the selected users to play the first multimedia presentation.

68. The platform of claim 65 wherein the distribution process comprises a publish process operable to make selected ones of the multimedia presentations produced by a first one of the users available for playback by subscribing ones of the users.

69. The platform of claim 65 wherein the distribution process comprises a publish process operable to make selected ones of the multimedia presentations produced by a first subset of the users available for playback by any of the users.

70. The platform of claim 65 wherein the distribution process comprises a publish process operable to insert a link to a first one of the multimedia presentation on a third party site such that visitors to the third party site may select the link to initiate playback the first multimedia presentation.

71. The platform of claim 70 wherein the first multimedia presentation comprises an advertisement for which revenue may be derived in response to playback of the first multimedia presentation by the visitors to the third party site.

72. The platform of claim 65 wherein each of selected ones of the multimedia presentations represents a profile of a corresponding one of the users, and wherein the distribution process comprises a publish process operable to facilitate playback of the selected multimedia presentations as introductions to the corresponding users.

73. The platform of claim 65 wherein the at least one computing device comprises a plurality of computing devices configured in a wide area network, at least some of the computing devices being associated with the users, and wherein control of the production and distribution processes are distributed among the plurality of computing devices.

74. The platform of claim 73 wherein the computing devices associated with the users comprise one or more of a desktop computer, a laptop computer, a handheld telecommunications device, a personal digital assistant, an email client, a digital appliance, or a set-top box.

75. At least one computer-readable medium having data structures stored therein representative of a multimedia presentation, the data structures representing visual objects and audio objects configured as a plurality of frame objects, the frame objects being further configured as a sequence represented by a presentation object, wherein the presentation object, the frame objects, and the visual and audio objects are configured in relation to each other such that instantiation of each of the frame objects results in simultaneous instantiation of the associated visual and audio objects, and instantiation of the presentation object results in sequential instantiation of the frame objects such that the multimedia presentation appears to be a continuous video presentation.

76. The at least one computer readable medium of claim 75 wherein the data structures represent multiple copies of selected ones of the visual and audio objects optimized for presentation on different types of devices.

77. The at least one computer readable medium of claim 75 wherein a first one of the frame objects has multiple ones of the audio objects associated therewith, and wherein instantiation of the first frame object results in one of instantiation of only one of the multiple associated audio objects, or sequential instantiation of the multiple associated audio objects.

78. The at least one computer readable medium of claim 75 wherein a first one of the frame objects has multiple ones of the audio objects associated therewith, and wherein the multiple audio objects comprise one or more of different language versions of similar content, or different content versions intended for different audiences.

79. The at least one computer readable medium of claim 75 wherein a first one of the frame objects has multiple ones of the audio objects associated therewith, and wherein the first frame object includes a plurality of tracks each of which corresponds to one of the multiple associated audio objects, the first frame object also having only a first one of the visual objects associated therewith, the first visual object being associated with only a first one of the tracks, wherein instantiation of the first frame object in accordance with any one of the tracks results in presentation of the first visual object.

80. The at least one computer readable medium of claim 75 wherein an image corresponding to a first user is associated with first selected ones of the audio objects such that the first user image is displayed during portions of the multimedia presentation corresponding to the first selected audio objects.

81. The at least one computer readable medium of claim 80 wherein an image corresponding to a second user is associated with second selected ones of the audio objects such that the second user image is displayed during portions of the multimedia presentation corresponding to the second selected audio objects.

82. The at least one computer readable medium of claim 81 wherein one of the first selected audio objects and one the second selected audio objects are associated with a first one of the frame objects such that both images are displayed during a portion of the multimedia presentation corresponding to the first frame object.

83. The at least one computer readable medium of claim 75 wherein each of a plurality of subsets of the frame objects is associated with one of a plurality of scene objects represented by the data structures, each of the scene objects representing a different branch of the multimedia presentation, wherein instantiation of the presentation object results in alternate instantiation of the scene objects.

84. The at least one computer readable medium of claim 75 wherein a control object is associated with a first one of the frame objects such that the control object is presented during the multimedia presentation in conjunction with instantiation of the first frame object, the control object being operable to call a remote process.

85. The at least one computer readable medium of claim 75 wherein the presentation object, the frame objects, and the visual and audio objects are further configured in relation to each other such that an alternative instantiation of the presentation object results in simultaneous presentation of multiple representations of the frame objects, each frame object representation being selectable by a viewer to effect playback of the corresponding frame object.
